(19) United States
(12) Patent Application Publication
(10) Pub. No.: US 2025/0363425 A1
(43) Pub. Date: Nov. 27, 2025

(54) MACHINE LEARNING MODEL ANALYSIS AND CLASSIFICATION

(71) Applicant: YISSUM RESEARCH DEVELOPMENT COMPANY OF THE HEBREW UNIVERSITY OF JERUSALEM LTD., Jerusalem (IL)

(72) Inventors: Eliahu HORWITZ, Jerusalem (IL); Jonathan KAHANA, Jerusalem (IL); Asaf SHUL, Jerusalem (IL); Bar CAVIA, Modi’in (IL); Or NATHAN, Jerusalem (IL); Nitzan KURER, Jerusalem (IL); Liel AMAR, Jerusalem (IL); Yedid HOSHEN, Jerusalem (IL)

(21) Appl. No.: 19/214,351

(22) Filed: May 21, 2025

Related U.S. Application Data
(60) Provisional application No. 63/650,153, filed on May 21, 2024.
(60) Provisional application No. 63/707,792, filed on Oct. 16, 2024.
(60) Provisional application No. 63/753,991, filed on Feb. 5, 2025.
(60) Provisional application No. 63/771,093, filed on Mar. 13, 2025.

(51) Int. Cl. G06N 20/20

(52) U.S. Cl. CPC G06N 20/20

(57) ABSTRACT

A computer-implemented method comprising: receiving, as input, a set of machine learning models associated with a repository of models, wherein a creation time for each of the models in the set with respect to the repository is known; determining a distance measure with respect to each pair of models in the set, based, at least in part, on a set of internal learned representations which determine how each of the models processes and encodes input data; and predicting, for each model m in the set, a parent model p from which the model m was generated via additional training, based, at least in part, on (x) the distance measure, and (y) temporal order and distance determined based on the creation time, between the model m and the parent model p.

### CROSS-REFERENCE TO RELATED APPLICATIONS

This application claims the benefit of priority of U.S. Provisional Patent Applications Ser. No. 63/650,153, filed May 21, 2024, entitled “MODEL TREE HERITAGE RECOVERY;” Ser. No. 63/707,792, filed Oct. 16, 2024, entitled “REPRESENTING MODEL WEIGHTS WITH LANGUAGE USING TREE EXPERTS;” Ser. No. 63/753,991, filed Feb. 5, 2025, entitled “ZERO-SHOT MODEL SEARCH FROM WEIGHTS;” and Ser. No. 63/771,093, filed Mar. 13, 2025, entitled “CHARTING AND NAVIGATING HUGGING FACE'S MODEL ATLAS,” the contents of all of which are incorporated herein by reference in their entirety.

### FIELD OF THE INVENTION

This invention relates to the field of machine learning.

### BACKGROUND

The number and diversity of neural networks and machine learning models shared on public or private repositories have been growing at an unprecedented rate. For instance, on the popular model repository Hugging Face alone, there are over one million models, with thousands more added daily. In addition, many proprietary or enterprise repositories exist which contain large numbers of models.

However, currently, there is scant information that would enable potential public or enterprise users to navigate publicly-available neural networks. Most models shared online lack structured representation which captures model evolution and parentage, the tasks that models are configured to perform, and how well they perform these tasks.

Such structured information would allow users, for example, to easily discover and reuse existing models, rather than training new ones from scratch, saving resources and reducing environmental impact. Structured model information would also allow the reconstruction of the parentage or heritage of models, i.e., to discover parent-child relationship between models, such as when one model originated from a previous model via additional training or fine-tuning, or when two models originated from a common ancestor model. Moreover, structured model information could serve to index and catalog the machine learning landscape, facilitating comparisons across techniques and modalities, and highlighting emerging trends.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in an embodiment, a computer-implemented method comprising: receiving, as input, a set of machine learning models associated with a repository of models, wherein a creation time for each of the models in the set with respect to the repository is known; determining a distance measure with respect to each pair of models in the set, based, at least in part, on a set of internal learned representations which determine how each of the models processes and encodes input data; and predicting, for each model m in the set, a parent model p from which the model m was generated via additional training, based, at least in part, on (x) the distance measure, and (y) temporal order and distance determined based on the creation time, between the model m and the parent model p.

There is also provided, in an embodiment, a system comprising at least one processor; and a non-transitory computer-readable storage medium having stored thereon program instructions, the program instructions executable by the at least one processor to: receive, as input, a set of machine learning models associated with a repository of models, wherein a creation time for each of the models in the set with respect to the repository is known, determine a distance measure with respect to each pair of models in the set, based, at least in part, on a set of internal learned representations which determine how each of the models processes and encodes input data, and predict, for each model m in the set, a parent model p from which the model m was generated via additional training, based, at least in part, on (x) the distance measure, and (y) temporal order and distance determined based on the creation time, between the model m and the parent model p.

There is further provided, in an embodiment, a computer program product comprising a non-transitory computer-readable storage medium having program instructions embodied therewith, the program instructions executable by a computer system to: receive, as input, a set of machine learning models associated with a repository of models, wherein a creation time for each of the models in the set with respect to the repository is known; determine a distance measure with respect to each pair of models in the set, based, at least in part, on a set of internal learned representations which determine how each of the models processes and encodes input data; and predict, for each model m in the set, a parent model p from which the model m was generated via additional training, based, at least in part, on (x) the distance measure, and (y) temporal order and distance determined based on the creation time, between the model m and the parent model p.

In some embodiments, the method further comprises constructing, and the program instructions are further executable to construct, a visualized graph representation of the set of machine learning models, wherein each of the models m in the set is a node in the graph, wherein each of the nodes is connected with a directed edge to a respective parent model p thereof.

In some embodiments, the predicting is performed iteratively for each of the models m in the set, in a temporal order based on the creation time, by: (i) determining a subset K of nearest neighbors of the model m, based on the distance measure, (ii) calculating a correlation between (a) the distance measures and (b) temporal distances determined based on the creation time, between the model m and each of the models in the subset K, (iii) when the correlation exceeds a predetermined threshold, designating as the parent model p the nearest one of the models in the subset K having a the creation date which precedes the creation date of the model m, and (iv) when the correlation is below the predetermined threshold, designating as the parent model p the model in the subset K having the earliest the creation time.

In some embodiments, the internal set of learned representations are learned weight representations, wherein the distance measure is based on measuring a Euclidean distance between each pair of the models in the set based on their respective the learned weight representations.

In some embodiments, the predicting is further based, at least in part, on a difference in a number of outlier values in the learned weight representations of model m and parent model p, wherein a lower the number of outlier values indicates a model which has undergone additional training.

In some embodiments, the method further comprises, and the program instructions are further executable to perform, the following steps: (i) identifying duplicate pairs of the models in the set when the distance measure between a pair of the models is below a distance threshold, and (ii) removing from the set one of the models in each of the identified duplicate pairs.

In some embodiments, an indication of a quantization process is known for each of the models in the set, and the method further comprises designating, and the program instructions are further executable to designate, each of the models having the indication of a quantization process as a leaf node in the visualized graph representation.

In some embodiments, the creation time indicates a time of creation or an uploading time for each of the models in the set with respect to the repository.

In addition to the exemplary aspects and embodiments described above, further aspects and embodiments will become apparent by reference to the figures and by study of the following detailed description.

### BRIEF DESCRIPTION OF THE FIGURES

The present invention will be understood and appreciated more comprehensively from the following detailed description taken in conjunction with the appended drawings in which:

FIG. 1 shows a block diagram of an exemplary computing system configured to execute at least some of the computer code involved in performing the inventive methods.

FIG. 2 plots the weight distance vs. model tree edge distance for pairs of models.

FIGS. 3A-3B plot the change in the directional weight score throughout the pre-training (generalization) stage (FIG. 3A) and fine-tuning (specialization) stage (FIG. 3B).

FIG. 4A shows all possible model graphs of size 3.

FIG. 4B schematically shows a model graph construction process.

FIG. 5A is a flowchart of the functional steps in a method for unsupervised model tree mapping over a set of machine learning models, based on determining for pairs of models in the set (i) if the models are directly related, and (ii) the direction of the relationship.

FIG. 5B schematically show a variation of a method for unsupervised model tree mapping over a set of machine learning models, based on determining for pairs of models in the set (i) if the models are directly related, and (ii) the direction of the relationship.

FIG. 6A depicts a portion of the experimental dataset used by the inventors.

FIG. 6B shows the reconstruction of a Stable Diffusion Model Tree.

FIG. 7A shows the correlation between temporal dynamics and edge directionality.

FIG. 7B schematically depicts snake vs. fan patterns.

FIG. 8 is a flowchart of the functional steps in a method for unsupervised construction of a structured visualization representation of a set of machine learning models.

FIG. 9A shows model tree distribution of the 10 largest model trees on Hugging Face.

FIGS. 9B-9D show experimental results.

FIG. 10A depicts the pipeline of a process for training and implementing a probing expert model of the present technique.

FIG. 10B depicts a schematic overview of a probing model of the present technique.

FIG. 11 is a flowchart of the functional steps in a method for training a probing model configured to predict the class categories used in the training dataset of a target unseen model.

FIG. 12 shows schematically a zero-shot inference overview according to the present technique.

FIG. 13 schematically depicts probing descriptors, according to the present technique.

FIG. 14 schematically depicts text-aligned probing descriptors, according to the present technique.

FIG. 15A is a flowchart of the functional steps in a method for generating a probing descriptor representing an output target concept-of-interest of a trained machine learning model.

FIG. 15B is a flowchart of the functional steps in a method for generating a probing descriptor from a text prompt representing a semantic target concept-of-interest

FIG. 16 presents the results of a collaborative probing test.

FIG. 17 presents results of text retrieval on the INet-Hub dataset using increasing numbers of probes.

### DETAILED DESCRIPTION

Disclosed herein are techniques, embodied in systems, methods, and computer program products, for analyzing trained machine learning models, to obtain and reconstruct structured information regarding the machine learning models, without access to model training data.

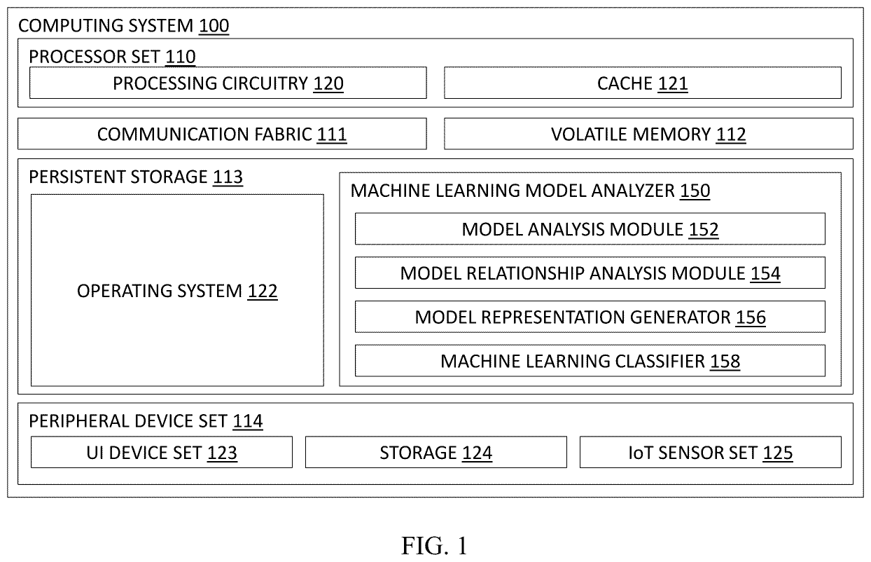

Reference is made to FIG. 1, which shows a block diagram of an exemplary computing system 100 configured to execute at least some of the computer code involved in performing the inventive methods disclosed herein.

In this example, computing system 100 includes a processor set 110 (including processing circuitry 120 and a cache 121), a communication fabric 111, a volatile memory 112, a persistent storage 113 (including an operating system 122 and a machine learning model analyzer block 150), and a peripheral device set 114 (including a user interface (UI), a device set 123, a storage 124, and an Internet of Things (IoT) sensor set 125).

Computing system 100 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network and/or querying a database, such as a remote database. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computing system 100, to keep the presentation as simple as possible. computing system 100 may be located in a cloud, even though it is not shown in a cloud in FIG. 1. On the other hand, computing system 100 is not required to be in a cloud except to any extent as may be affirmatively indicated.

Processor set 110 includes one or more computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computing system 100 to cause a series of operational steps to be performed by processor set 110 of computing system 100 and thereby effect a computer-implemented method, such that the instructions thus executed will instantiate the method(s) specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computing system 100 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computing system 100, volatile memory 112 is located in a single package and is internal to computing system 100, but, alternatively or additionally, the volatile memory may be distributed over multiple packages and/or located externally with respect to computing system 100.

Persistent storage 113 is any form of non-volatile storage for computers that is now known or to be developed in the future. The non-volatility of this storage means that the stored data is maintained regardless of whether power is being supplied to computing system 100 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface type operating systems that employ a kernel.

The code included in block 150 typically includes at least some of the computer code involved in performing the inventive methods, including a model analysis module 152, a model relationship analysis module 154, a model representation generator 156, and/or a machine learning classifier 158.

Peripheral device set 114 includes the set of peripheral devices of computing system 100. Data communication connections between the peripheral devices and the other components of computing system 100 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the Internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computing system 100 is required to have a large amount of storage (for example, where computing system 100 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

### Machine Learning Model Tree Construction

In some embodiments, the present technique provides for determining relationships between two or more machine learning models. In some embodiments, the present technique provides for determining relationships between two or more machine learning models, based, at least in part, on analyzing and interpreting trained model wights. Thus, the present technique may provide for studying the relationship between the weights of related models, to determine the parentage or heritage of models, e.g., determine a parent-child relationship between models, such as when one model originated from a previous model via additional training or fine-tuning, or when two models originated from a common ancestor model.

In some embodiments, the present technique may thus provide for reconstructing relationships and hierarchies among a collection of related models, which may be represented as a directed model tree, which represents the existence and direction of the relationship between each pair of models in the collection of related models. In some embodiments, the present technique further provides for extending the model tree into a model graph, by representing entire model ecosystems comprising multiple model trees.

In some embodiments, the present technique provides for analyzing trained machine learning models, in order to determine the task and purpose of the models. In some embodiments, the present technique provides for analyzing trained machine learning models in order to determine the task and purpose of the model, based, at least in part, on analyzing and interpreting trained model wights. In one example, the present technique provides for analyzing trained machine learning model weights, in order to determine whether a particular model is trained to provide an output corresponding to a particular query concept, such as performing a specified classification task. In this example, the present technique may provide for searching for one or more machine learning models, e.g., in a repository of machine learning models, that are trained to perform the specified classification task.

### Determining Pairwise Model Relationship

As noted above, the number of models shared in public or proprietary repositories has grown exponentially in recent years.

However, most models shared in repositories are not well documented, with most model metadata (e.g., model cards) either missing altogether or severely lacking. For example, the inventors analyzed over 800,000 model cards from Hugging Face. It was found that at least 36% of all models (roughly 290K) do not have model cards. The present investors used an AI model to analyze those models having cards, and found that for about 510K remaining models, about 35% of model cards had no useful information about the pre-training models. Overall, about 60% of the models (about 470K) have no model cards or have uninformative model cards. Even for the 330K or so models with informative cards (about 40% of all models), the cards often did not describe their parentage, but rather just the root node. Based on a manual inspection of 500 randomly sampled model cards, it is estimated that fewer than half of the remaining models (about 165K) have parent node indication.

Accordingly, the present technique provides for unsupervised model tree construction for mapping collections of neural networks, based on determining the relationships between pairs of models in the collection. In some embodiments, for each pair of models, the present technique provides for (i) determining if the models are directly related, and (ii) establishing the direction of the relationship.

In some embodiments, the present technique is based on techniques used to analyze the internal representations learned by machine learning models. In some embodiments, the present technique is based on analyzing machine learning model weights, which are learned traits that determine the strength of a connection between any two of the neurons that make up the content of the neural network underlying the model.

In some embodiments, based on analyzing models weights, the present technique provides for decoding the relationships among a collection of models. Specifically, the present technique is based on the insight that the distance between the weights of a pair of models correlates with their node distance on the model tree. This, in turn, is based on analyzing the evolution of model weights over the course of training, wherein it may be observed that the number of weight outliers changes monotonically over the course of training, including increasing during the generalized training stage, and decreasing during any following specialization stage (often referred to as fine-tuning).

Using these insights, it is possible to construct a model tree for a given set of models, by determining whether each pair of models is directly connected and establishing the direction of the relationship. Specifically, the present technique uses weight distance analysis to create a pairwise distance matrix between models, and the outlier monotonicity to create a binary edge direction matrix. Then, a minimum directed spanning tree algorithm may be applied to the combined matrices, to construct the model tree. In some embodiments, the present technique extends the model tree to a model graph which represents entire ecosystems of models comprising multiple model trees, by first clustering the nodes based on their pairwise distances.

### Model Tree and Model Graph

In some embodiments, the present technique employs a model tree data structure for describing the origin of models stemming from a base model (e.g., a foundation model).

Consider a set of models [symbol] , where the base model v_{b}∈ [symbol] serves as the root node. Every model v∈ [symbol] \{v_{b}}, is trained in a specialization stage (e.g., fine-tuned) from another model in the set. The model from which v was fine-tuned is referred to as its parent model, and denoted by Pa(v). Conversely, v is referred to as a child of Pa(v). A parent can have multiple children (including none), while all models (except the root) have only one parent. The set of tree edges is denoted by [symbol] , where each directed edge between a parent and its child is represented as e=(Pa(v),v). Overall, the model tree [symbol] is defined by its nodes and directed edges, [symbol] =( [symbol] , [symbol] ). In addition, d(u, v) denotes the number of edges on the shortest path in [symbol] ₊ between the nodes u and v. The tree [symbol] ₊ is the same as tree [symbol] , except that the directed edges are replaced by undirected ones.

A collection of model trees [symbol] ₁, . . . , [symbol] ₙ forms a forest of model tress, which is termed herein a ‘model graph.’ The model graph is defined as [symbol] =(V=V₁ ∪ . . . ∪Vₙ, [symbol] = [symbol] ₁ ∪ . . . ∪ [symbol] ₙ). In a model graph, d(u, v) is only defined if u, v∈Tᵢ, when u∈ [symbol] ᵢ and v∈ [symbol] ⱼd, d(u, v) is undefined. Note that all the models within a model tree share the same underlying neural network architecture. As the architecture of a model is given by its weights, and since different architectures necessarily belong to different trees, it may be assumed without loss of generality that all v∈V are of the same architecture.

Due to the large number and diversity of published models, the structure of the model graph is unknown and is non-trivial to estimate. Accordingly, in some embodiments, the present technique provides for solving the technical task of model tree construction, for mapping the structure of a model graph over a collection of unseen trained models. The task of model tree and graph construction may have multiple practical applications. For example, model and graph tree construction may provide for determining the parentage and origin of a given model, e.g., whether a given model is based on specialization (i.e., fine-tuning) of a foundation model. In another example, model tree and graph construction may be used for metadata imputation, that is, the ability to recover and assign structured model information, including training data, original foundation model, and descendent models, to models missing such information.

This task may be defined formally as follows: given a set of models V, the goal is to construct the structure of the model graph [symbol] =(V, [symbol] ) based solely on the weights of the models v∈V. Since a model graph is a forest of model trees, the task involves two main steps: (i) cluster the nodes into different components [symbol] ₁, [symbol] ₂, . . . , where each component is a model tree with an unknown structure, and (ii) construct the structure of each model tree [symbol] . Essentially, as each graph is defined by its vertices and edges, the task is to construct the directed edges [symbol] using the weights of v∈ [symbol] .

### Estimating Node Distance From Model Weights

In some embodiments, the present technique provides for predicting a distance between a pair of models, based, at least in part, on an analysis of model weights. In some embodiments, the present technique then uses the distance between the pair of models to determine whether the models are related via an edge within the model tree.

Weight distance between a pair of models u and v may be determined by analyzing uₗ and vₗ, denoting the weight matrix of layer l of models u and v respectively,

$${ℓ}_{FT} ( u , v ) = \frac{1}{L} {\sum }_{l = 1}^{L} {ℓ}_{2} ( {u}_{l} , {v}_{l} ) \qquad ( 1 )$$

where L is the number of model layers.

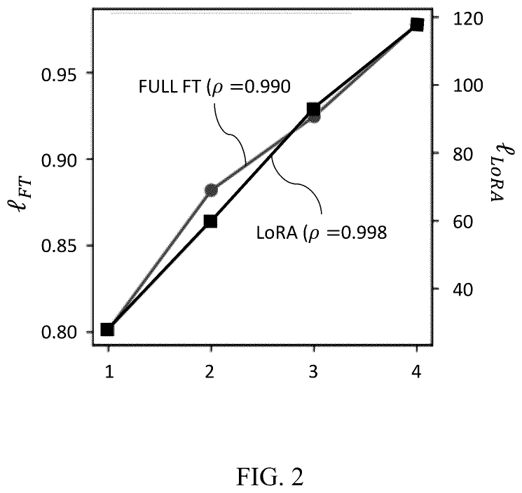

In some embodiments, the present technique is based on studying the weight distance [symbol] _{FT}(u, v) (wherein FT denotes full fine-tuning of the model) between pairs of models as a function of the edge distance d(u, v) between their respective nodes on the model tree. FIG. 2 plots the relationship between these two distances (ρ=0.99). It is evident that nodes with direct parent-child connections (i.e., models fine-tuned from one another) have the lowest weight distance of 1. Thus, it may be concluded that a low [symbol] _{FT} distance between two models is highly correlated with an edge between their nodes an vice versa.

FIG. 2 also plots the weight distance [symbol] _{LORA}(u, v). As can be seen, a low LoRA weight distance between two models is highly correlated with an edge between their nodes. LoRA (see, Edward J Hu, et al. Lora: Low-rank adaptation of large language models. arXiv preprint arXiv:2106.09685, 2021) has become the dominant method for parameter-efficient fine-tuning. LoRA is designed to fine-tune large-scale models efficiently by targeting a small subset of the model's weights that have the most significant impact on the task at hand. Consequently, a model fine-tuned via rank r LoRA differs from its base model by a matrix of at most rank r for each layer. Furthermore, two models fine-tuned from the same base model using rank r₁ and r₂ LoRAs differ from each other by a matrix of at most rank r₁+r₂ per layer. This property may be used to provide a better estimate of the node distance between LoRA models and define the LoRA weight distance as:

$${ℓ}_{LoRA} ( u , v ) = {max}_{l} ( rank ( {u}_{l} - {v}_{l} ) ) \qquad ( 2 )$$

where L is the number of fine-tuned LoRA layers. In practice, the rank is computed using singular value decomposition (SVD), where the rank is the number of singular values greater than some threshold E.

### Estimating Edge Direction From Weights

The direction of an edge between two nodes u and v reflects whether model v was trained from u or vice versa. The weight distance determined as detailed hereinabove cannot determine the direction because it is symmetric. Estimating the direction of edges requires a statistic of the weights that evolve monotonically during training. Accordingly, in some embodiments, the present technique uses kurtosis (i.e., fourth moment) and define the directional weight score as:

$$k ( u ) = {\sum }_{l ∈ L} \frac{E [ {( {u}_{l} - μ )}^{4} ]}{{( E [ {( {u}_{l} - μ )}^{2} ] )}^{2}} \qquad ( 3 )$$

where L is a set of model layers and μ is the mean of the layer weights l. Note that the directional score only defines an order between related nodes, and that unrelated nodes may have different scores.

The inventors studied the effectiveness of this score, by calculating Equation (3) at multiple points throughout the training process of two families of models, to determine how the weights of a model evolve throughout the training process, including the generalized stage and the fine-tuning or specialization stage.

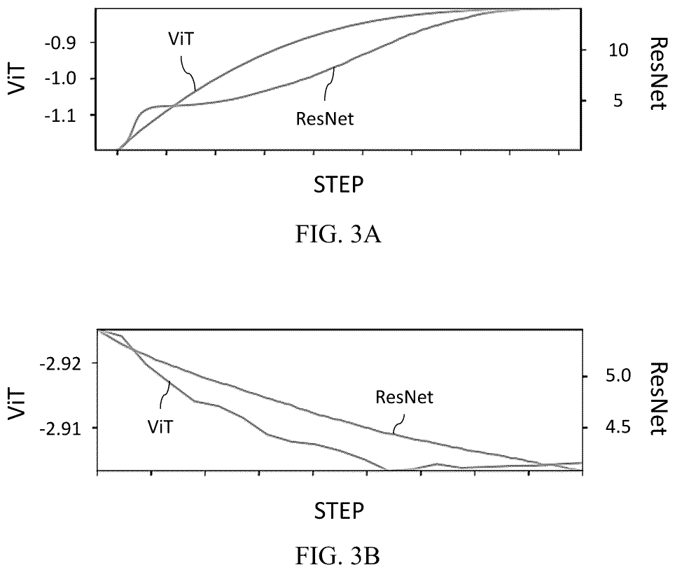

FIGS. 3A-3B plot the changes in the directional weight score throughout the pre-training (generalization) stage (FIG. 3A) and fine-tuning (specialization) stage (FIG. 3B) of two families of models:
ResNet (see, Kaiming He, et al. Deep residual learning for image recognition. In Proceedings of the IEEE conference on computer vision and pattern recognition, pages 770-778, 2016).
ViT (see, Alexey Dosovitskiy, et al. An image is worth 16×16 words: Transformers for image recognition at scale. arXiv preprint arXiv:2010.11929, 2020).

As seen in FIGS. 3A-3B, the directional score is substantially monotonic, indicating the increasing number of weight outlier values during generalization and the decreasing number during specialization. Thus, although the score is monotonic in both stages, it increases during generalization and decreases during specialization. The generalization stage usually corresponds with model pre-training, whereas the specialization stage with model fine-tuning. This confirms that the directional weight score is effective for determining the direction of an edge between pairs of parent and child models.

It should be noted, however, that the term fine-tuning is typically used for any training performed after the initial pre-training stage. However, generalization training may also take place in an already pre-trained model. Therefore the terms generalization and specialization are more preferable to “pre-training” and “fine-tuning.”

In some embodiments, the present technique is based on the intuition that, during the generalization stage, to better encode large, general-purpose datasets, the weights of a model will likely take an increasing number of diverse values. This may lead to an increase in the number of outlier values in the weight matrix. In contrast, during the specialization stage, the weights of a model with a lower value diversity will likely suffice to encompass the smaller, task-specific data. This may lead to a decrease in the number of outlier values in the weight matrix. Kurtosis, as a measure of the tailedness of a distribution, captures this property.

### Model Tree Construction

In some embodiments, the present technique provides for constructing model graphs over a collection of models, given access to the models' weights as well as indication of the training stage of each node (i.e., generalization or specialization), but without prior knowledge regarding pairwise model relations within the collection. Each model graph may contain one or more model trees. Connected nodes within a model tree are derived from each other via additional training steps. Unless otherwise specified, it is assumed that no prior knowledge regarding the model relations.

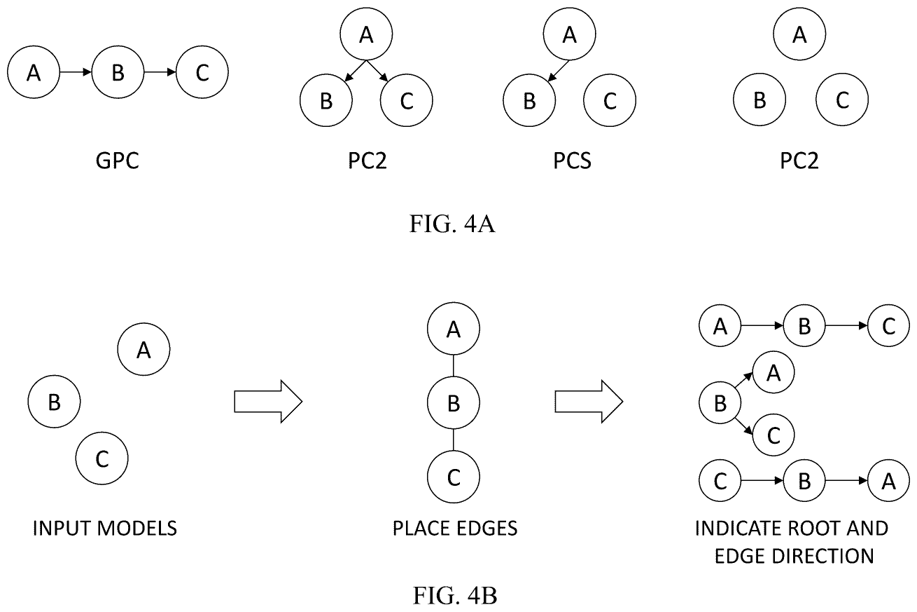

FIG. 4A shows all possible model graphs of size 3. FIG. 4B schematically shows a model graph construction process: (i) providing a set of 3 input models with no prior knowledge regarding their relations is provided, (ii) adding edges between pirs of nodes with the lowest weight distance, and (iii) designating the node with the highest directional weight score as the root of the model tree. In all these cases, heredity relations between models are represented as directed edges. The present technique clusters a given set of models (in this case, three input models) into different model trees based on the pairwise weight distances. For each cluster, the present technique uses the weight distance [symbol] _{FT} or [symbol] _{LoRA} to create a pairwise distance matrix D for placing edges. The present technique then creates a binary directional matrix K based on the kurtosis, to determine the direction of each edge. To construct the final model tree, the present technique then may run a minimum directed spanning tree (MDST) algorithm on the merged prior matrix M. The final constructed model graph is the union of the constructed model trees.

To construct a model graph of size 3, edges are placed between the nodes with the lowest weight distance, wherein the node with the highest directional weight score is designated as the root. An example of such model tree is the Grandparent-Parent-Child (GPC) model tree, which exhibits a 3-generational relationship, where each node is derived from the previous one (as shown in FIG. 4A). To construct the underlying model tree structure, the weight distance [symbol] _{FT} is used to place edges between node pairs with the lowest weight distances, based on the analysis detailed hereinabove under “Estimating Node Distance From Model Weights.” Next, to determine the order of the nodes, Equation (3) hereinabove is used to designate the node with the highest score as the root. Combining these steps fully constructs the GPC model tree, as shown in FIG. 4A. This process is based on a specialization training stages for all 3 models. To adjust the process for models having undergone a generalization stage, the sign of the directional score is simply reversed. When the training stages of each node differ, the sign is selected according to each node's training stage (e.g., generalized training or specialized training).

Another example is a Parent-Child-Child (PC2) model tree. This model tree contains one parent with two children (see FIG. 4A). As in the GPC case, edges are added between nodes using the weight distance defined as detailed hereinabove. Since both children are derived from the root, the directional score will predict the node with the highest score as the root. Different training stages are handled as in the GPC case.

A third example is a Parent-Child-Stranger (PCS) model tree. Unlike the previous cases (GPC and PC2), PCS is a model graph comprising two model trees (see FIG. 4A). To construct this structure, first identify the node with no edge according to the pairwise weight distance. Since that node belongs to a different model tree, it will have a larger distance than a set threshold, allowing it to be classified as the odd one. With the node isolated, the protocol of the previous model trees can be carried out for the two remaining nodes.

A fourth example is a Stranger-Stranger-Stranger (S3) model tree. This is a model graph comprising 3 model trees (see FIG. 4A). Similar to PCS, the nodes can be clustered into different model trees based on their large distances.

### Scaling Up Model Graph Construction

In some embodiments, the present technique provides for constructing the structure of larger model graphs, comprising a collection more than 3 models. Let v₁, . . . , vₙ∈ [symbol] be a set of nodes representing different models. It is assumed initially that all models in the set v₁, . . . , vₙ∈ [symbol] belong to the same model tree.

The present technique provides for determining the edges [symbol] of the model tree [symbol] , by placing edges between pairs of nodes comprising a parent-child relationship (i.e., wherein one model was trained from the other model). As seen above, constructing the model tree structure requires a combination of the estimated weight distance and the edge direction between each pair of models. Let D be a weight distance matrix and let K be a binary directional matrix,

$${D}_{ij} = \{ \begin{matrix}ℓ ( {v}_{i} , {v}_{j} ) , & ifi \neq j \\ ∞ , & otherwise\end{matrix} , {K}_{ij} = \{ \begin{matrix}1 , & ifk ( {v}_{i} ) < k ( {v}_{j} ) \\ 0 , & otherwise\end{matrix} \qquad ( 4 )$$

To allow for both generalization and specialization node relations, T is defined as a binary matrix:

$${T}_{ij} = \{ \begin{matrix}1 , & ifgeneralization \\ 0 , & otherwise\end{matrix} \qquad ( 5 )$$

The final distance matrix for constructing the model tree takes into account all 3 constraints as follows,

$${M}_{ij} = D + λ ( K ⊕ T ) \qquad ( 6 )$$

where ⊕ is a binary XOR and λ regularizes the directional score, allowing for some mistakes. Since [symbol] _{FT} and [symbol] _{LoRA} may range in value, λ is defined to be proportional to D with

$$λ = c \cdot ( \frac{1}{{n}^{2}} {\sum }_{i , j = 1}^{n} {D}_{ij} )$$

where c is some constant. In practice, the results are virtually unchanged for values of c∈(0,5). Accordingly, c=0.3 may be selected as the constant.

The present technique then provides for constructing the model tree from M using a minimum directed spanning tree (MDST) algorithm, such as the Chu-Liu-Edmonds algorithm (see, Yoeng-Jin Chu. On the shortest arborescence of a directed graph. Scientia Sinica, 14:1396-1400, 1965; Jack Edmonds et al. Optimum branchings. Journal of Research of the national Bureau of Standards B, 71(4): 233-240, 1967.6), which iteratively contracts cycles in the graph until forming a tree. The algorithm proceeds as follows: initially, it treats each node as a temporary tree. Then, it merges the temporary trees via the incoming edge with the minimum weight. Subsequently, it identifies cycles in the remaining temporary trees and removes the edge with the highest weight. This merging process continues until all cycles are eliminated, resulting in the minimum directed spanning tree. The algorithm runs in O(EV), however, faster MDST algorithms exist with O(E+VlogV).

Initially, it was assumed that all v₁, . . . , vₙ are from the same model tree. In some embodiments, the present technique provides for handling a collection of models selected from general model populations, wherein at least some of the models cannot be assumed to be related. In such case, v₁, . . . , vₙ are first clustered into different components based on their pairwise distances, using Equations (1) and (2) discussed hereinabove. Then, the present technique provides for running the algorithm on each of the clusters independently. In some cases clustering may be performed based on the model architecture. However, many unrelated known foundation models share the exact same architecture. For instance, multiple public models all use a VIT-B architecture, despite being completely unrelated.

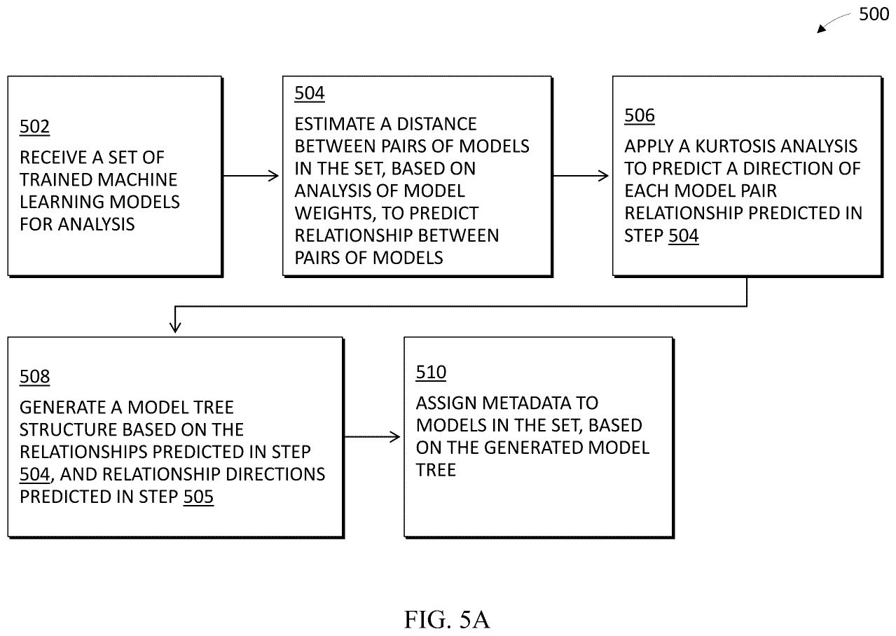

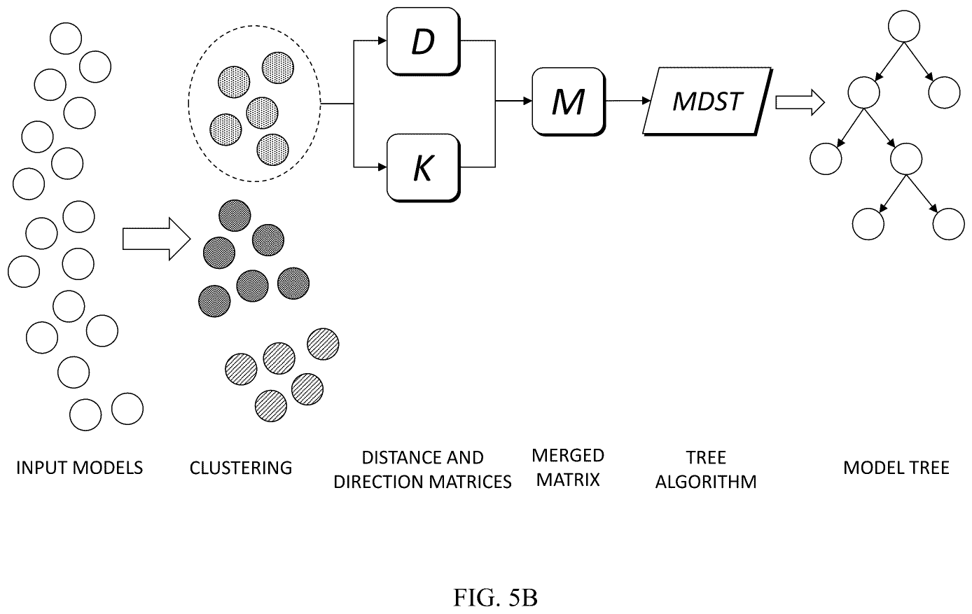

With continued reference to FIG. 1, the instructions of machine learning model analyzer block 150 are now discussed with reference to the flowchart of FIG. 5A, which details the functional steps in a method 500 which provides for unsupervised model tree mapping over a set of machine learning models, based on determining for pairs of models in the set (i) if the models are directly related, and (ii) the direction of the relationship. In some embodiments, method 500 provides for constructing a model graph [symbol] =( [symbol] [symbol] ) for a set of models V, based on the weights of the models v∈ [symbol] .

Steps of method 500 may either be performed in the order they are presented or in a different order (or even in parallel), as long as the order allows for a necessary input to a certain step to be obtained from an output of an earlier step. In addition, the steps of method 500 are performed automatically (e.g., by computing system 100 of FIG. 1, or by any other applicable component of computing environment 100), unless specifically stated otherwise.

Method 500 begins in step 502, wherein machine learning model analyzer block 150 receives a set of trained machine learning models. In some embodiments, the set of trained machine learning models may be obtained from a repository of machine learning models, such as a public or proprietary repository.

In some embodiments, at least some of the models in the received set of machine learning models are not associated with known structured information regarding each particular model, such as training scheme (e.g., generalized or specialized training), original foundation model, and/or one or more descendent models.

In some embodiments, the models in the received set represent a mix of models having different attributes, including, but not limited to:
Models based on different neural network architectures with different layer structures.
Models representing generalized or specialized training.
Models representing specialized training using different specialized training methods, such as full fine-tuning, different variations of LoRA-based fine-tuning, or mixed full and LoRA-based fine-tuning.
Models trained using similar or identical fine-tuning methods, based on different seed parameters.
Models representing different pruning and/or quantization methods.
Models descended from one or more other models in the set.
Models that are parents to one or more other models in the set.

In step 504, machine learning model analyzer block 150 executes model analysis module 152 to estimate a distance between each pair of models in the received set, based, at least in part, on an analysis of model weights. In some embodiments, machine learning model analyzer block 150 executes model analysis module 152 to use the distance estimated between each pair of models to predict whether the models are related in a parent-child relationship, wherein a parent-child relationship is indicated via an edge connecting the pair of models within the constructed model tree. In some embodiments, machine learning model analyzer block 150 executes model analysis module 152 to predict whether a pair of models are related in a parent-child relationship based on the weight distance between the pair of models. In some embodiments, machine learning model analyzer block 150 executes model analysis module 152 to predict whether a pair of models are related in a parent-child relationship based on the weight distance between the pair of models, wherein the prediction is further based on a ranking algorithm, a clustering algorithm, and/or the application of minimum or maximum predetermined thresholds.

Accordingly, in some embodiments, machine learning model analyzer block 150 executes model analysis module 152 to determine a weight distance between a pair of models u and v by analyzing uₗ and vₗ, denoting the weight matrix of layer l of models u and v respectively, using the equation

$${ℓ}_{FT} ( u , v ) = \frac{1}{L} {\sum }_{l = 1}^{L} {ℓ}_{2} ( {u}_{l} , {v}_{l} ) ,$$

where L is the number of model layers.

In some embodiments, in the case of pairs of models trained based on LoRA, machine learning model analyzer block 150 executes model analysis module 152 to estimate the node distance between the pair of LoRA-trained models using the equation

$${ℓ}_{LoRA} ( u , v ) = {max}_{l} ( rank ( {u}_{l} - {v}_{l} ) ) ,$$

where L is the number of fine-tuned LoRA layers.

In some embodiments, at the conclusion of step 504, machine learning model analyzer block 150 executes model analysis module 152 to generate a pairwise distance matrix D representing the estimated weight distances between each pair of models in the received set.

In step 506, machine learning model analyzer block 150 executes model relationship analysis module 154 to predict a direction associated with each edge connecting pairs of models within the received set, as determined in step 504.

In some embodiments, machine learning model analyzer block 150 executes model relationship analysis module 154 to use kurtosis (i.e., fourth moment) to estimate the directional weight score as

$$k ( u ) = {\sum }_{l ∈ L} \frac{E [ {( {u}_{l} - μ )}^{4} ]}{{( E [ {( {u}_{l} - μ )}^{2} ] )}^{2}} ,$$

where L is a set of model layers and μ is the mean of the layer weights l.

In some embodiments, machine learning model analyzer block 150 executes model relationship analysis module 154 to generate a binary directional matrix K based on estimated directional weight scores, to determine the direction of each edge.

In step 508, machine learning model analyzer block 150 executes model representation generator 156 to generate a model tree structure based on the pairwise distance matrix D representing the estimated weight distances between each pair of models in the received set generated in step 504, and the binary directional matrix K based on predicted directional weight scores representing the direction of each edge, generated in step 506.

In some embodiments, machine learning model analyzer block 150 executes model representation generator 156 to generate a model tree structure based on the pairwise distance matrix D representing the predicted weight distances between each pair of models in the received set generated in step 504, and the binary directional matrix K based on predicted directional weight scores representing the direction of each edge, generated in step 506, based on the equations

$${D}_{ij} = \{ \begin{matrix}ℓ ( {v}_{i} , {v}_{j} ) , & ifi \neq j \\ ∞ , & otherwise\end{matrix} , {K}_{ij} = \{ \begin{matrix}1 , & ifk ( {v}_{i} ) < k ( {v}_{j} ) \\ 0 , & otherwise\end{matrix} ,$$

where T is defined as a binary matrix:

$${T}_{ij} = \{ \begin{matrix}1 , & ifgeneralization \\ 0 , & otherwise\end{matrix} .$$

The result is a merged matrix M which takes into account all 3 constraints as follows: Mᵢⱼ=D+λ(K⊕T), where ⊕ is a binary XOR and λ regularizes the directional score. Since [symbol] _{FT} and [symbol] _{LoRA} may range in value, λ is defined to be proportional to D with

$$λ = c \cdot ( \frac{1}{{n}^{2}} {\sum }_{i , j = 1}^{n} {D}_{ij} ) ,$$

where c is some constant of value c∈(0,5).

In some embodiments, machine learning model analyzer block 150 then executes model representation generator 156 to apply a minimum directed spanning tree (MDST) algorithm to merged matrix M, to construct the model tree from M.

In step 510, machine learning model analyzer block 150 assigns, based on the model tree generated in step 508, structured metadata to at least some of the models in the received set, comprising one or more of:
Training method.
Original foundation model.
Descendent models.

The steps of method 500 as described hereinabove may be applicable in the case where all the models in the set of models received in step 502 belong to the same model tree, i.e., are all rooted in the same foundation or parent model.

In the case that step 502 comprises receiving a set of models which comprises multiple model trees, the steps of method 500 may be applied recursively, separately to with respect to each model tree in the set. As overview of this process is shown in FIG. 5B. Accordingly, in such cases, method 500 provides for an intermediate step following step 504 of clustering the received set of models into different model trees, based on the estimated pairwise weight distances calculated in step 504. Then steps 506-508 of method 500 are performed with respect to each such cluster separately, to create the pairwise distance matrix D and the binary directional matrix K for each cluster, merge the two matrices M, and construct the model tree for the cluster. This process is repeated with respect to all cluster, to construct model tress for each of the clusters. The final model graph may be then constructed based on a union of all of the constructed model trees.

### Experimental Results

The inventors evaluated the performance of the present technique using an experimental dataset comprising more than 500 models organized in different model trees. The dataset comprises four main distinct sub-graphs:
LoRA-V: LoRA fine-tuning with varying ranks.
LoRA-F: LoRA fine-tuning with fixed ranks.
FT: full fine-tuning.
Mixed: mixed LoRA and full fine-tuning.

In the experimental dataset subsets, the following models as the model tree roots, as taken from Hugging Face:

https://huggingface.co/google/vit-base-patch16-224.
https://huggingface.co/google/vit-base-patch16-224-in21k.
https://huggingface.co/facebook/vit-mae-base.
https://huggingface.co/facebook/dino-vitb16.
https://huggingface.co/facebook/vit-msn-base.

Each subset contains 105 models in 3 levels of hierarchy, and is comprised of 5 model trees rooted by different, unrelated pre-trained ViT-based models found on Hugging Face. The second level of each model tree contains 4 models fine-tuned on randomly chosen datasets from the VTAB benchmark (see, Xiaohua Zhai, et al. A large-scale study of representation learning with the visual task adaptation benchmark. arXiv preprint arXiv:1910.04867, 2019). Each second-level model has 4 child nodes, fine-tuned with randomly sampled VTAB datasets while ensuring they are different than their parent model. All of the models are labeled as specialization-trained. In addition, a deeper model tree (Deep) was constructed with 121 models in 5 levels of hierarchy as well as a ResNet50 model tree (ResNet) with 21 models in 3 levels of hierarchy. In addition to the experimental dataset, the present technique was evaluated on the Stable Diffusion model tree found on Hugging Face.

The evaluation metric used was accuracy, wherein a correct prediction is one where both the edge placement and direction are correct. In all the experimental tests, the present technique ran in seconds to minutes even on a CPU. For clustering the model graph into different model trees, hierarchical clustering was used over the [symbol] ₂ pairwise distance, wherein knowledge of the number of clusters is assumed. In addition, the “scipy” implementation (see, Pauli Virtanenet al. SciPy 1.0: Fundamental Algorithms for Scientific Computing in Python. Nature Methods, 17:261-272, 2020. doi: 10.1038/s41592-019-0686-2.7) with the default hyperparameters.

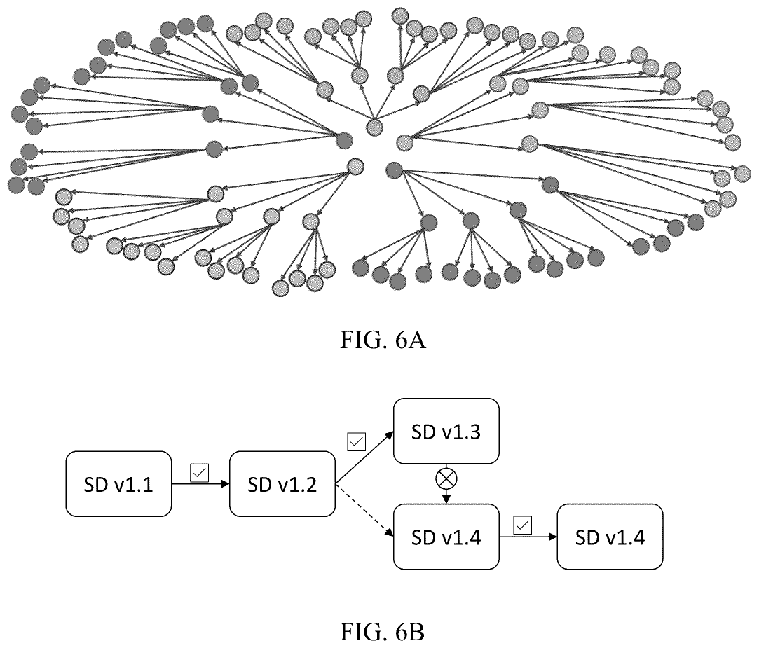

FIG. 6A depicts a portion of the experimental dataset, which simulates a model graph consisting of over 20 model trees with a total of over 500 models fine-tuned on varying datasets with different hyperparameters. Four main distinct sub-graphs may be distinguished, differing in backbone and fine-tuning paradigm. FIG. 6A shows the ground truth structure of a single sub-graph that contains 105 models across the following 5 model trees, each rooted in a different foundation model:
ImageNet (https://www.image-net.org/).
ImageNet-21 k.
MAE (see, Kaiming He, et al. Masked autoencoders are scalable vision learners. In Proceedings of the IEEE/CVF conference on computer vision and pattern recognition, pp. 16000-16009, 2022.7).
DINO (see, Mathilde Caron, et al. Emerging properties in self-supervised vision transformers. In Proceedings of the IEEE/CVF international conference on computer vision, pp. 9650-9660, 2021.7).
MSN.

LoRA fine-tuning. The experiments started by testing the present technique on the LoRA sub-graphs of the experimental dataset. L was set in Equations (2) and (3) discussed hereinabove to be all the LoRA fine-tuned layers of the model. The first test studied the performance of LoRA fine-tuned models with varying ranks, i.e., wherein the rank of the difference between two pairs of models is likely to be different and therefore discriminative. As can be seen in Table 1 below, all 5 model trees within the sub-graph were successfully reconstructed with perfect accuracy. In contrast, when all models use the same rank, the variance between different models decreases, resulting in a reduced accuracy for one of the 5 model trees.

TABLE 1
The present technique achieves high accuracy both for individual
model trees and entire model graphs. Each sub-graph comprises
105 models from 5 model trees, the Mixed sub-graph simulates
a real-world repository where models from the same model
tree use either LoRA or full fine-tuning.

| | | ImageNet- | | | | Model |
|---|---|---|---|---|---|---|
| Sub-graph | ImageNet | 21k | MAE | DINO | MSN | Graph |
| LoRA-V | 1.0 | 1.0 | 1.0 | 1.0 | 1.0 | 1.0 |
| LoRA-F | 1.0 | 1.0 | 1.0 | 1.0 | 0.8 | 0.96 |
| FT | 0.85 | 0.85 | 1.0 | 1.0 | 1.0 | 0.94 |
| Mixed | 0.9 | 0.9 | 0.9 | 0.9 | 0.9 | 0.83 |

To ablate whether the LoRA-based [symbol] _{LoRA} distance defined in Equation (2) is necessary, the above experiment was repeated with [symbol] _{FT} defined in Equation (1). Not using the low-rank distance prior reduces the results on LoRA-V by 22% to 0.78, demonstrating the significance of [symbol] _{LoRA} for LoRA fine-tuned models.

Full fine-tuning. A second test was conducted in cases where all the models used full fine-tuning. As before, the clustered sets are used, and the present technique is run on each set independently. L in Equation (1) is set to all the model layers, and Equation (3) to be all the dense layers of the model. For 3 out of the 5 model trees in the dataset, the present technique successfully reconstructs the tree structure with perfect accuracy. The other two model trees suffered from a wrong directional score, which resulted in an imperfect reconstruction. The full breakdown is shown in Table 1 above. The present technique also generalizes to other architectures, as demonstrated by constructing the structure of the ResNet model tree with perfect accuracy.

Mixed LoRA and full fine-tuning. A final test was conducted to create a sub-graph to simulate real model repositories where model trees contain models that use different fine-tuning paradigms. In particular, a model graph was constructed where the fine-tuning method is randomly chosen to be either full fine-tuning or LoRA fine-tuning (with fixed rank). Since the weights of models that used full fine-tuning are full rank, Equation (1) must be used and set L to be all the model layers. Similar to the drop in performance when using [symbol] _{FT} with LoRA fine-tuned models, here too there is some decrease in performance, resulting in an overall accuracy of 0.9 as can be seen in Table 1 above.

Next, the inventors applied the present technique to construct the model tree of unknown model sets found on Hugging Face with ground truth metrics.

Stable Diffusion The Hugging Face model cards for Stable Diffusion describe a 4 level hierarchy spanning 5 of their models. These are: (i) Stable Diffusion 1.1, (ii) Stable Diffusion 1.2, (iii) Stable Diffusion 1.3a, (iv) Stable Diffusion 1.4, and (v) Stable Diffusion 1.5. The [symbol] _{FT} distance described above was used, however, since the different model versions are better and more generalized foundation models, they were treated as generalization nodes (i.e., the directional score is now flipped, as seen in Equation (5)). As seen in FIG. 6B, the present technique successfully reconstructs all but a single edge, incorrectly placing Stable Diffusion 1.4 as a descendent of Stable Diffusion 1.3, instead of as a descendant of Stable Diffusion 1.2 and a sibling of Stable Diffusion 1.3. Notably, the mistake occurred due to a wrong distance, as the directional score returned the correct edge direction.

Robustness to similar models. Foundation models often come with fine-tuning recipes. As such, many publicly available models are almost identical to each other, often with just a different seed. The inventors tested the robustness of the present technique with 3 identically fine-tuned versions of ViT that used different seeds. In all 3 cases, the distance between sibling models was greater than to the parent model, allowing to correctly construct the model tree.

Deeper and larger model trees. The inventors tested whether the present technique could scale to deeper and larger model trees. To this end, the inventors trained a 5-level hierarchy of ViT models, rooted at the ImageNet foundation model. Each iₜₕ level model has 3 child models, resulting in a set of 121 models, all belonging to the same model tree. Indeed, although this structure has 6×more nodes and is 2×deeper (the root to leaf path is now 4 edges instead of 2), there is only a small decrease in accuracy, from 0.85 to 0.79.

Clustering robustness to smaller model graphs. The inventors tested whether the clustering step can handle small model graphs. The results indicate that even with as few as 10 models (across 5 model trees), the clustering achieves high accuracy, indicating the present technique could be performed even for small yet diverse model graphs.

Other directional scores. The directional score of the present technique (Equation (3)) uses kurtosis to estimate the distributional change in outliers of weight values. However, other directional scores may be used. The inventors compared the performance using the variance, skewness, kurtosis, and entropy methods. To do so, the inventors fine-tuned each of the root models from the experimental dataset, and extracted intermediate weights throughout the training process. The kurtosis is the only metric that demonstrated consistent monotonicity across the different models.

Effect of layers types. Neural networks often contain multiple layer types (e.g., linear, convolutional, attention). The inventors therefore tested the change in the directional score for different layer types throughout the fine-tuning process. Despite different types of layers exhibiting similar trends on average, the dense layer remained consistent across all model trees.

Robustness to Pruning and Quantization. The present technique is robust to pruned and quantized models. For example, with 90% pruning, the accuracy decreases by only 4%. In the extreme case where 99% of weights are pruned, the present method still achieves 68% accuracy (random baseline is roughly 5%). Moreover, when 50% of the models underwent quantization, the performance of the present method decreases by less than 1%.

### Structured Representation and Visualization of Machine Learning Model Landscape

As noted above, the number of models shared in public or proprietary enterprise repositories has grown exponentially in recent years. Thus, the ability to search and analyze large model repositories becomes increasingly important. Navigating many models requires a structured representation, but as most models are poorly documented, charting such a structured representation is a challenging task.

Accordingly, in some embodiments, the present technique provides for constructing a structured visualized representation of given collections of machine learning models. The present technique provides for a structured representation capturing the evolution of collections of models, what tasks they solve, and how well they perform is carrying out these tasks.

In some embodiments, the present technique provides for a method for constructing structured representations and mapping of collections of machine learning models, based on structured data associated with each machine learning model.

In some embodiments, the present technique provides for predicting, for each model m in a set of machine learning models associated with a repository, a parent model p, wherein model m originated from parent model p via additional training or fine-tuning. In some embodiments, the present technique provides for predicting, for each model m the set, a parent model p, based, at least in part, on (i) a distance measure determined with respect to each pair of models in the set, based on an internal set of learned representations of each model in the set, and (ii) a temporal distance between model m and parent model p.

In some embodiments, the internal set of learned representations is known for each of the models in the set. In some embodiments, the internal set of learned representations determines how each of the models in the set processes and encodes input data. In some embodiments, the internal set of learned representations are learned weight representations of each model. In such cases, the distance between each pair of models is based on measuring a Euclidean distance between the pair of models based on their respective learned weight representations.

In some embodiments, the temporal distance is based on a creation time associated with each model with respect to the repository. In some embodiments, the creation time indicates a time of creation or an upload time for each of the models in the set with respect to the repository.

In some embodiments, the parentage predicting is performed iteratively for each model m in the set, in a temporal order based on their creation time, by:
determining a subset K of nearest neighbors of model m, based on a distance measure,
calculating a correlation between (a) the distance measures, and (b) temporal distances determined based on the creation time, between model m and each of the models in the subset K,
when the correlation exceeds a predetermined threshold, designating as the parent model p of model m, the nearest one of the models in the subset K having a creation date which precedes the creation date of model m, and
when the correlation is below the predetermined threshold, designating as the parent model p of model m, the model in the subset K having the earliest creation time.

In some embodiments, the present technique further provides for first identifying model duplicates in the set, based on a distance measure between a pair of the models that is below a distance threshold. In some embodiments, the present technique provides for removing from the set one of the models in each identified duplicate pairs. In some embodiments, the distance threshold is equal to zero.

In some embodiments, the present technique further provides for designating models having an indication of having undergone a quantization process as ‘leaf’ node models, which do not have child models.

In some embodiments, the present technique provides for constructing a visualized graph representation of the set of models, wherein each of the models m in the set is a node in the graph, and wherein each of the nodes is connected with a directed edge to a respective the parent model p thereof, based on the parentage predictions.

The present technique addresses the practical challenge of navigating and charting the machine learning model landscape, by creating a structured representation of model repositories. Taking Hugging Face as a case study, the inventors demonstrate that its model landscape representation has more complex structure than previously thought. In particular, the model repository is comprised, at least in part, of non-tree directed acyclic graph (DAGs), rather than of model trees (where each model is a direct or indirect descendant of a foundation model). Therefore, the model landscape may be very deep. The inventors present several use cases for the model landscape structured representation, including analyzing model training trends and completing missing model documentation.

The present technique for constructing a structured representation of collections of models provides visualizations of the model landscape and its evolution. In some embodiments, the present technique has multiple practical applications. For example, the present technique enables users to easily discover and reuse existing models rather than training new ones from scratch, saving resources and reducing environmental impact. Moreover, the present structured representation serves as a visualized snapshot of the entire machine learning landscape, facilitating comparisons across techniques and modalities, and highlighting emerging trends in specific domains, such as computer visions or anomaly detection. The present technique can further assist users in predicting and assigning model attributes (such as accuracy) based on model positioning and location within the structured representation.

Accordingly, in some embodiments, the present technique provides to a method for charting undocumented regions. Specifically, the present technique identifies high-confidence structural priors based on dominant real-world model training practices. Leveraging these priors, the present approach enables accurate mapping of previously undocumented areas of the structured representation.

To establish the untapped potential of structured representations of large model repositories, the inventors first chart the documented regions of Hugging Face. This visualizations reveals the intriguing and complex structures of the machine learning model landscape. These visualizations are then used to analyze recent trends in computer vision models and to compare them across different modalities. For example, based on a structured representation of trend differences between Stable Diffusion and Llama, it becomes clear that Llama-based models employ more diverse training practices and dynamics, including quantization and model merging, resulting in more complex structures.

In some embodiments, the present structured representation can be used to predict both model tasks and their accuracy. For example, the prediction of the TruthfulnessQA metric of models derived from Mistral-7B (https://mistral.ai/news/announcing-mistral-7b) may be improved by simply observing their nearest neighbors in a structured representation.

In reality, model documentation only provides an initial glimpse of the structured representation, while the full picture remains elusive. Existing model metadata (e.g., model cards or configuration files) are often incomplete and lack critical details about model task, accuracy, and origin. The inventors tested the completeness of Hugging Face documentation and found that approximately 60% of the 1.5 million models lack any documentation. This is not only confined to niche models. For example, MobileNet has over 70 million monthly downloads yet only 5 documented fine-tunes. Consequently, prior research has explored model tree construction, representing models as nodes and their relation (e.g., fine-tuning) as edges. Most methods use probing or direct weight inspection, but they typically rely on unrealistic assumptions and fail to scale to the real-world.

To this end, the inventors developed a structured representation charting method for real-world model repositories. In particular, the inventors analyzed the harmful effects of duplicate or near-duplicate models on existing methods. This leads the present technique to identify and use priors on model relations that allow to predict the correct edges. Also, the increasing popularity of model merging violates the traditional tree-structure assumption. Accordingly, the inventors represent the present structured representation as a non-tree directed acyclic graph (DAG). The present proposed algorithm, informed by these assumptions, effectively constructs the structured representation structure of Hugging Face, achieving substantial performance improvements over baseline methods.

The present structured representation [symbol] consists of a set of machine learning models. Each machine learning model m∈ [symbol] has weights (parameters) w. It also has attributes including: the model's name, its upload time (t), parents (P) if known, training hyperparameters, performance on specific benchmarks, and/or download count. A child model m_{ch} is formed by transforming the weights of the parent model mₚₐ through operations like specialization training (e.g., fine-tuning), quantization, pruning, or merging. This is denoted by adding a directed edge (mₚₐ, m_{ch}) to the structured representation. A model with no parents is called a source model. As the weight transformation is causal, i.e., a model cannot be a descendant of itself, the present structured representation comprises a set of directed acyclic graphs (DAGs). A DAG is a directed graph with no directed cycles. A DAG consists of vertices and edges, with each edge directed from one vertex to another, such that following those directions will never form a closed loop. The DAGs are not assumed to be model trees, as some models can have multiple parents, particularly as a result of merges. Each connected component (CC) in a DAG can be viewed as a separate region.

The inventors analyzed the models on Hugging Face, the largest public model repository. The vast majority of models on Hugging Face are poorly documented, such that Hugging Face has labels for only 400,000 directed edges. Using these labels, the inventors constructed an initial structured representation which demonstrates its promise for analyzing recent trends, measuring model impact, predicting model accuracy and other attributes.

Although the initial structured representation comprises a small subset with only 63,000 models of the documented regions of Hugging Face, it already reveals significant trends. The 63,000 models span 28 connected components (CCs) with a total of over 65,000 edges. The LLM connected component is deep and complex. It includes almost a third of all models. In contrast, Flux, a text-to-image model (https://huggingface.co/black-forest-labs/FLUX.1-dev), while also substantial, has a structure that is much simpler and more uniform. The structured representation also highlights quantization practices across vision, language, and vision-language models. Vision models barely use quantization, despite Flux containing more parameters (12B) than Llama (8B). Conversely, quantization is commonplace in LLMs, constituting a large proportion of models. Vision-language models demonstrate a balance between these extremes. A notable distinction exists between discriminative and generative vision models. Discriminative models primarily employ fine-tuning, while generative models have widely adopted practices such as LoRA. The evolution of this adoption over time is evident: Stable-Diffusion 1.4 (SD) mostly used full fine-tuning, while SD 1.5, SD 2, SD XL, and Flux progressively use more fine-tuning adapters. Interestingly, the structured representation reveals that audio models rarely use adapters, suggesting gaps in cross-community knowledge transfer. This inter-community variation is particularly evident in model merging. LLMs have embraced model merging, with merged models frequently exceeding the popularity of their parents. This raises interesting questions about the limited role of merging in vision models.

The initial structed representation of Hugging Face shows that NLP models have a wide range of DAG depths, while in computer vision models, nearly all models have a direct edge to the root foundation model. This suggests that the computer vision community puts more focus on new foundation models, while the NLP community often embraces iterative refinement. As an example, the LLM CC exhibits significant depth and complexity, representing almost a third of the models. In contrast, while Flux is also substantial, its structure is much simpler and more uniform.

The initial structed representation of Hugging Face shows that the computer vision community has not adopted the use of quantization (less than 0.15% of all models in this pool). Meaning, vision models have not yet reached the scale where inference time is too costly and quantization is essential. However, Flux, one of the newest and largest generative models, is the rare exception in terms of quantization among vision models. This indicates that image generation models may have just reached the scale where quantization is valuable.

The initial structed representation of Hugging Face shows a striking difference between generative and discriminative models, in that the vast majority of generative models use adapters (e.g., LoRA) while almost all discriminative models use full fine-tuning. The structured representation also allows to track how trends evolve. Thus, adapters can be traced over time to see that they are becoming more prevalent. For example, only 50% of older models (such as SD1.4) use parameter-efficient adapters, while in newer versions it is much more common. The newest generative models, such as Flux or Llama 3, have much more parameter-efficient trained models.

The initial structed representation of Hugging Face shows that the rate of model merging in NLP is approximately 35 times higher than that of vision models. Merged NLP models had, on average, 30% higher influence (total descendant downloads) than their non-merged sibling models. While not a causal relationship, this hints that more research into merging vision models can be fruitful.

Local structured representation regions contain related models. Therefore, the structured representation may also be useful for predicting non-documented model attributes, including task, accuracy, license, missing weights, and popularity.

By analyzing over 314 k models, the inventors found that over 96% of computer vision models are situated one node away from the root, while only 55% of NLP models have this shallow depth. Over 5% of NLP models have depth of at least five nodes. This shows that NLP models are much deeper than computer vision models, suggesting the NLP community embraces iterative refinement over new moving to the latest foundation models.

Currently, fewer than 15% of Hugging Face models have accuracy details. This is a serious limitation as users typically want to select accurate models for their task. Even worse, there are very few models that report the same accuracy metrics on the same datasets. Surprisingly, the challenge is not limited to unpopular models, as many popular models do not report accuracy metrics in easily processed form. Here, the inventors demonstrate that the model DAG can help predict model accuracy. To test this, the inventors used the Mistral-7B CC which contains 17.5 k models. Only 300 models were labeled with their performance on the TruthfulQA metric. In some embodiments, the accuracy of each unlabeled node may be predicted using the average of its K nearest neighbor (NN) nodes, where distance is measured by path length on the undirected version of the model DAG.

Table 1C below shows the results of structured representation-based documentation imputation. Using structured representation structure improves prediction of model accuracy and other attributes, compared to naively using the majority label.

TABLE 1C

| | Method | MSE | MAE | Correlation |
|---|---|---|---|---|
| TruthfulQA | Baseline | 100.217 | 8.541 | — |
| | 1-NN | 32.830 | 3.247 | 0.856 |
| | 2-NN | 28.720 | 3.235 | 0.864 |
| | 3-NN | 25.544 | 3.147 | 0.877 |
| | 5-NN | 23.512 | 3.093 | 0.885 |
| Helleswag | Baseline | 95.000 | 7.500 | — |
| | 1-NN | 30.000 | 3.000 | 0.860 |
| | 2-NN | 27.000 | 2.900 | 0.870 |
| | 3-NN | 24.000 | 2.800 | 0.880 |
| | 5-NN | 22.000 | 2.700 | 0.890 |

The present structured representation can predict other model attributes besides the accuracy. Here, the present technique relies on model hubs, which are sets of sibling leaf models (79% of models are members of some hub). The idea is that models in hubs are very similar to one another, and therefore the present technique can complete their missing values by the majority class of labeled nodes within the same hub. The inventors tested hub-based predictions on 5 attributes that are often missing on Hugging Face, including: license, model, and inheritance types. Table 2C below compares this method with the graph-level majority label. It improves significantly, including a 35% gain in accuracy for license prediction and 19% improvements for both inheritance type and pipeline tag prediction.

TABLE 2C

| Attribute | Graph Avg. | Hub Avg. |
|---|---|---|
| Pipeline | 0.60 | 0.79 (+0.19) |
| Library Name | 0.81 | 0.84 (+0.02) |
| Model Type | 0.66 | 0.81 (+0.15) |
| License | 0.49 | 0.85 (+0.35) |
| Relation Type | 0.61 | 0.80 (+0.19) |

There are several ways of measuring the impact of a model. For example Hugging Face uses likes, trends (based on an undisclosed proprietary algorithm) and downloads. These metrics are somewhat myopic, as they measure the direct popularity of models but not the popularity of their descendant models. In fact, a graph analysis reveals that for 50% of non-leaf nodes, the total downloads of their descendants exceed their own individual downloads. This is partially due to the popularity of quantized child models and to incremental improvement of child models, e.g., finetuning or merging. The present analysis further showed that for non-leaf models, the sum of descendant nodes downloads exceeds those of the model itself in most cases (often by large margins). This suggests that simple model download counts underestimate the influence of the parent model.

In some embodiments, the present technique uses the structured representation to introduce a new model impact metric focused on the sum the downloads of the model node and those of all its descendants. This number describes how many downloads this model causally affected. It has important applications to intellectual property rights, as the models and data used to train the target models affected all of its downstream downloads. It also quantifies the social impact of the biases of this model.

There are legal and commercial reasons for removing models from repositories. Some models have been removed from the repository over time, affecting the integrity of the model DAGs. Out of 33,870 identified source models, 1,612 are missing due to deletion. A notable case is Stable Diffusion v1-5, which has 3,038 broken references. To preserve the integrity of the dependency structure, the missing node was reconstructed and its connections manually restored.

The above description highlighted the importance of the model structured representation. However, in practice, over 60% of it is unknown. This is primarily because model uploaders frequently do not provide parent model information. The present structured representation aims to construct the missing edges.

Accordingly, the present technique provides an approach suitable for structured representation charting of a received set of machine learning models. In some embodiments, at least some of the models in the received set of machine learning models are not associated with known structured information regarding each particular model, such as training scheme (e.g., generalized or specialized training), original foundation model, and/or one or more descendent models.

In some embodiments, the models in the received set represent a mix of models having different attributes, including, but not limited to:
Models based on different neural network architectures with different layer structures.
Models representing generalized or specialized training.
Models representing specialized training using different specialized training methods, such as full fine-tuning, different variations of LoRA-based fine-tuning, or mixed full and LoRA-based fine-tuning.
Models trained using similar or identical fine-tuning methods, based on different seed parameters.
Models representing different pruning and/or quantization methods.
Models descended from one or more other models in the set.
Models that are parents to one or more other models in the set.
Models that are an identical of near duplicate of another model in the set.
Models that are the result of merging two or more other models in the set.

In some embodiments, the present technique provides for charting the received set of models based, at least in part, on pairwise model distances with respect to a predetermined model property. In some embodiments, the predetermined model property is associated with an internal set of representations learned by each model, wherein the internal set of representations determines how a model processes and encodes input data.

In some embodiments, the predetermined model property is associated with one or more of: model weights, model activations, model gradients, model outputs, model metadata, or a combination of one or more of the above.

However, this approach does not generalize to unknown model sets. The reasons for this include the findings that (i) models with the nearest weight distance are not always connected by an edge, and (ii) the model structured representation is generally not a model tree where all models are related to one another by parent-child relationships.

Accordingly, the present technique provides for a set of charting rules motivated by special patterns in model repositories: duplication, quantization near-duplications, checkpoint trajectories, hyperparameter search, and merging. Identifying and handling these patterns can dramatically improve charting accuracy.

### Initial Clustering

In some embodiments the present technique generates an initial representation of pairwise models in the received set of models, based on model distances. Thus, the present technique measures the distance between two models i,j, using the Euclidean distance of their weight representations Wᵢ, Wⱼ:

$${D}_{ij} = {‖ {w}_{i} - {w}_{j} ‖}^{2} \qquad ( 1 A )$$

In some embodiments, the present technique then clusters the models in the received set into non-overlapping subsets using a standard clustering algorithm on the weight distance matrix, wherein each subset corresponds to the nodes within a single connected component of the structured representation. Thus, the present technique can construct the structure of each connected component separately. The naive strategy first assigns source nodes (this will be elaborated on below), then, at each step, it looks for the unassigned node with the shortest distance to the assigned nodes, and connects the two with a directed edge. The algorithm stops when there are no more unassigned nodes.

### Duplicates And Near-Duplicates

Real-world model repositories contain many model duplicates and near-duplicates. Exact duplicates occur when an existing model is re-uploaded one or more times to the repository without modification. In this, both the original and duplicates have identical distances to all models. This causes the greedy distance-based algorithm to arbitrarily decide between the true parent and its duplicates, which obviously reduces accuracy. To mitigate this, the present technique identifies models with zero-distance as exact duplicates, and retains only a single representative instance. The present technique achieves this by designating duplicate nodes as leaves.

### Quantization

Model quantization compresses models, in order to reduce memory and storage usage, and to accelerate their inferencing. Quantization thus transforms a model into a near-duplicate, as the values of each weight are typically very similar though not identical to the original model. This creates a similar ambiguity to exact duplicate models, as the distance of the original and quantized model to any other model are almost identical. Moreover, many models undergo multiple quantizations, which greatly increases this ambiguity. To overcome this ambiguity, the present technique identifies a pattern of quantization models from real-world structured representations. An analysis performed by the inventors reveals that 99.41% of quantized models on Hugging Face are leaf nodes, i.e., they have no child models. Intuitively, unquantized models have better performance than their quantized versions, and practitioners typically use the highest-performing models for further fine-tuning or merging. Thus detecting quantization is often straightforward. Quantized models have reduced precision data types (e.g., int8, float16 instead of float32) and fewer unique weight values. Therefore, the present technique addresses quantization by identifying quantized models and designating them as leaves.

### Temporal Relationships

Although the weight distance between models is inversely correlated to the likelihood of having an edge between them, it does not reveal the direction of the edge. In some embodiments, the present technique uses creation or upload timestamps to determine edge direction. The present technique is based on the fact that the vast majority of parent models have earlier timestamps than their children, specifically, in the Hugging Face model repository this occurs for 99.73% of all observed parent-child pairs. Accordingly, the present technique uses this temporal constraint in the present structured representation, and in particular identifies the source nodes as the earliest ones.

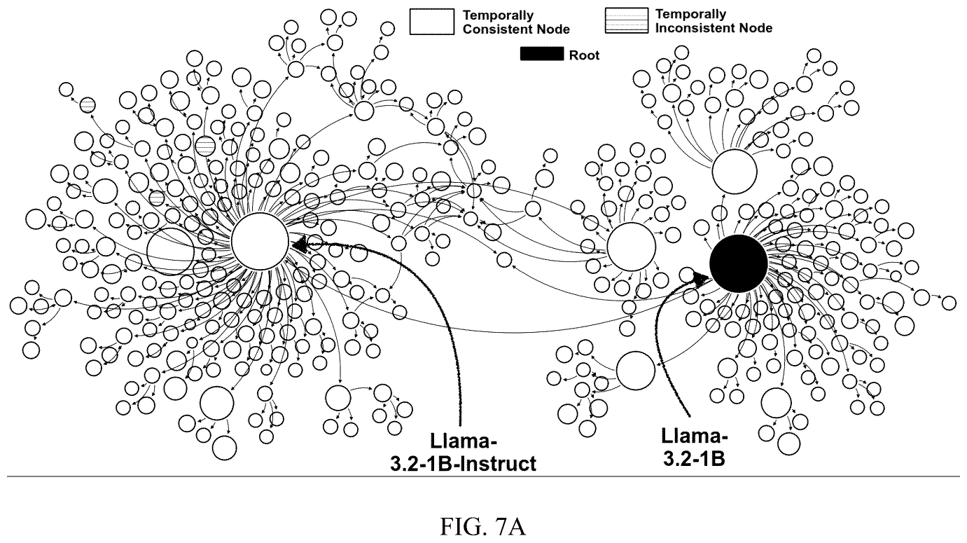

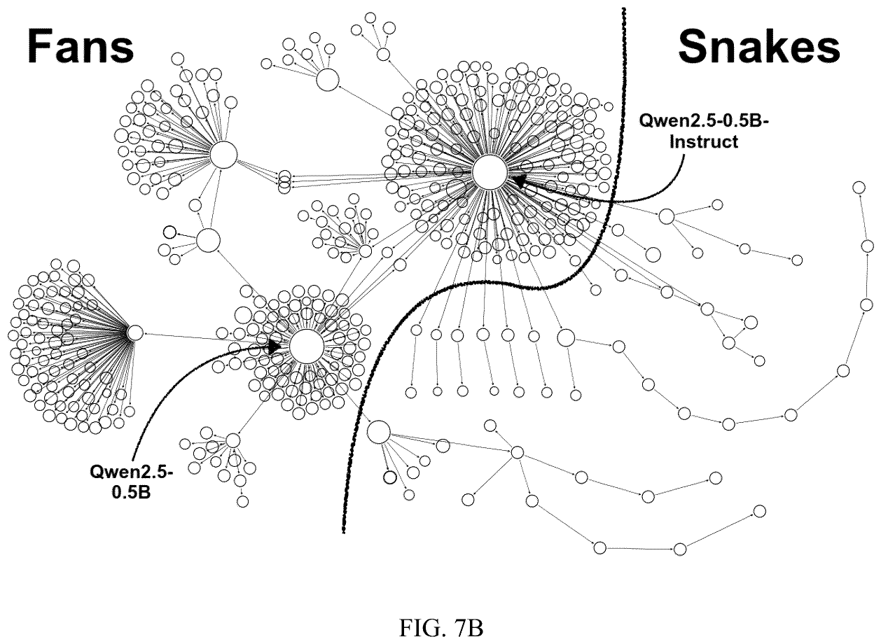

FIG. 7A shows the correlation between temporal dynamics and edge directionality. The inventors analyzed more than 400,000 documented model relationships and observed that in 99.73% of cases, earlier upload times correlate with topologically higher positions in the DAG. As can be seen in FIG. 7A, this trend is visualized on a subset of the Llama model family, wherein models nearer the root have earlier upload times.

### Model “Fans” And Model “Snakes”

Another limitation of the weight distance technique is that it may have limited sensitivity in fine-grained structures. Two common scenarios that challenge charting methods based on weight distance are hyperparameter sweeps and checkpoint trajectories. In hyperparameter sweeps, multiple models are trained from a single parent, each with different hyperparameters. Minor hyperparameter changes can result in sibling models having weight distances that are nearer to each other than to their common parent, defying the weight-based nearest neighbor logic. Conversely, checkpoint trajectories represent a sequence of models saved during a single training run. In this case, edges should connect consecutive checkpoints in a chain-like manner, rather than connecting each checkpoint directly to the initial model (as in the hyperparameter sweep scenario). The present technique terms the former pattern “fans” and the latter “snakes,” and finds that the weight distance often confuses these two patterns.

FIG. 7B schematically depicts snake vs. fan patterns. Snake patterns often arise from sequential training checkpoints, while fan patterns typically result from hyperparameter sweeps. In both structures the model weight variance is low. However, in snake patterns the weight distance has high correlation with model upload time, whereas in fan patterns the correlation is lower.

A key observation is that the temporal model weight evolution can discriminate between these patterns. In snake patterns, temporal proximity strongly correlates with weight proximity, due to the sequential evolution. However this is not the case in fan patterns, where the closest siblings are not necessarily the closest in time. This leads to a simple yet effective decision rule. If the weight distance of a model to its K nearest neighbors is highly correlated to their absolute temporal distance, the present technique classifies the pattern as a snake, otherwise a fan. Then, the present technique connects the node to one of its nearest neighbors depending on the detected structure. In snakes, the present technique connects the node to its first nearest neighbor based on weight distance, while in fans the present technique connects the node to its oldest nearest neighbor, aiming for the fan's origin.

Models with earlier timestamps are assumed to be topologically higher in the structured representation. For snake patterns, the parent is the closest preceding model; for fan patterns, it is the earliest model among the top K weight-based neighbors.

### Merged Models

As noted above, because merged models have multiple parents, they have more than one incoming edge. This cannot be described by model trees, but can be described by non-tree DAGs. The present technique is based on the fact that many merged models are created using a few popular libraries which typically document the parent nodes in the created model card, hence the multiple incoming edges are often known. The challenge left is to chart a DAG instead of a model tree. The present technique thus uses a greedy charting algorithm. The present technique first sorts all nodes by upload times. Then, the present technique processes each node in temporal order, predicts its parents, and adds those edges to the graph. In the case where the parents are known, the present technique uses these edges instead of predicting them. The algorithm stops where there are no more nodes to process. The runtime complexity is O(n²), where n is the number of models. In practice, the present technique constructs graphs with thousands of nodes in seconds.

The most expensive part of the algorithm in terms of computing overhead and storage is the distance matrix calculation, as it scales with the number of network weights. Therefore, the present technique provides for representing each model by subsampling the full weight representation to a much smaller number of neurons. Specifically, the present technique provides for representing models using only 100 neurons, which is typically sufficient for significantly speeding up the runtime while keeping accuracy nearly unchanged.

The full algorithm representing the present technique is detailed as Algorithm 1 pseudo-code hereinbelow. The input is a set of models M, each with weights w, creation time t, known parents P (or P=None), and whether it is quantized q. The algorithm has 3 hyperparameters: K—the number of neighbors, Kₜₕ, ρₜₕ—thresholds for snake-fan classification. The output of the algorithm is the predicted parents for each node m.P. this algorithm may be executed iteratively online over model collections, by computing the distance function and kNN as new models arrive.

Algorithm 1:

| \begin{lstlisting} | |
|---|---|
| # Input: M = {(w, q, t, P)}, K, Kₜₕ, ρₜₕ | # w = weights,t = |
| | creation time, P = |
| | known parents |
| # Sort M by timestamp t | |
| 1. M = M. sort(key = m. t) | |
| 2. D = compute_distance_matrix(M) | |
| 3. D. diag = inf | |
| # Set quantized model as leaf node | |
| 4. for i, m in enumerate(M): | |
| 5. if is_quantized(m. w): | |
| 6. D[i, :] = inf | |
| # Use existing parents if available | |
| 7. if m. P: | |
| 8. continue | |
| # Eliminate duplicates | |
| 9. for j in range(i + 1, len(M)): | |
| 10. if D[i, j] == 0: | |
| 11. D[j, :] = inf | |
| 12. M[j]. P = M[i]. P | |
| # Find k-NN | |
| 13. k_ind = argsort(D[:, i])[1: K] | |
| 14. temporal_k_ind = argsort(D[i + 1:, i])[1: K] | |
| 15. k_dist = D[k_ind, i] | |
| 16. k_times = [M[k]. t for k in k_ind] | |
| 17. temporal_k_times = [M[k]. t for k in temporal_k_ind] | |
| # Check spread of distances | |
| 18. if k_dist [−1] − k_dist[0] > Kₜₕ: | |
| 19. m. P = temporal_k_ind[0] | |
| 20. else: | |
| 21. corr = correlation(k_dist, abs(k_times − m. t)) | |
| 22. if corr > ρₜₕ: # Snake | |
| 23. m. P = temporal_k_ind[0] | |
| 24. else: | # Fan |

25. m. P = temporal_k_ind[argmin(temporal_k_times)]
end{lstlisting}
\end{algorithm}

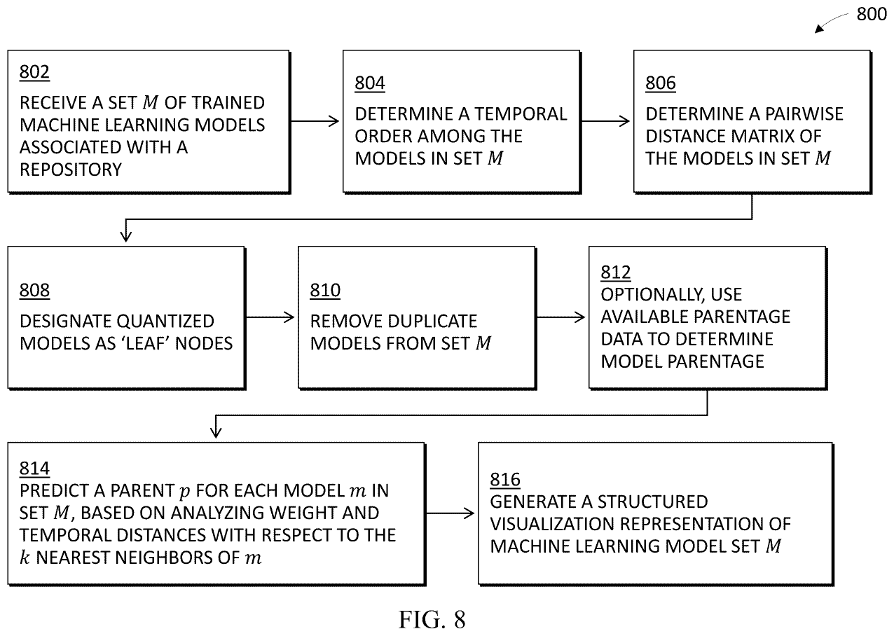

With continued reference to FIG. 1, the instructions of machine learning model analyzer block 150 are now discussed with reference to the flowchart of FIG. 8, which details the functional steps in a method 800 which provides for unsupervised construction of a structured visualization representation of a set of machine learning models. The steps of method 800 are detailed with continued reference to Algorithm 1 hereinabove, which represents the steps of method 800 in pseudo-code.

Steps of method 800 may either be performed in the order they are presented or in a different order (or even in parallel), as long as the order allows for a necessary input to a certain step to be obtained from an output of an earlier step. In addition, the steps of method 800 are performed automatically (e.g., by computing system 100 of FIG. 1, or by any other applicable component of computing environment 100), unless specifically stated otherwise.

Method 800 begins in step 802, wherein machine learning model analyzer block 150 receives a set M of trained machine learning models. In some embodiments, the set M of trained machine learning models may be obtained from or may represent a repository of machine learning models, such as a public or proprietary repository.

In some embodiments, at least some of the models in the received set M are not associated with known structured information regarding each particular model, such as training scheme (e.g., generalized or specialized training), original foundation model, and/or one or more descendent models.

In some embodiments, the models in the received set M represent a mix of models having different attributes, including, but not limited to:
Models based on different neural network architectures with different layer structures.
Models descended from one or more other models in the set.
Models that are parents to one or more other models in the set.
Models representing generalized or specialized training.
Models representing specialized training using different specialized training techniques, such as full fine-tuning, different variations of LoRA-based fine-tuning, or mixed full and LoRA-based fine-tuning.
Models trained using similar or identical fine-tuning methods, based on different seed parameters.
Models representing different pruning and/or quantization methods.
Models that are an identical of near duplicate of another model in the set.
Models that are the result of merging two or more other models in the set.
Models that are quantized versions of other models in the set.
Multiple models that trained from a single parent, each with different hyperparameters.
Sequences of models saved during a single specialized training run of a parent model.

In some embodiments, the set of models M comprises input data with respect to each of the models, including:
Model weights w.
Model creation or upload time t with respect to set M.
Model parentage data P, if known.
Model having undergone quantization q (yes/no).

In step 804, machine learning model analyzer block 150 executes model analysis module 152 to sort the models in set M in a temporal order, based on their respective creation time or upload time t within set M.

In step 806, machine learning model analyzer block 150 executes model analysis module 152 to process each of the models in set M in the temporal order established in step 804, to determine a distance matrix of all of the models in set M.

In some embodiments, machine learning model analyzer block 150 executes model analysis module 152 to estimate a distance between each pair of models in the received set M. In some embodiments, machine learning model analyzer block 150 executes model analysis module 152 to estimate a distance between each pair of models in the received set M based, at least in part, on pairwise model distances with respect to a predetermined model property. In some embodiments, the predetermined model property is associated with an internal set of representations learned by each model, wherein the internal set of representations determines how a model processes and encodes input data. For example, in some embodiments, the predetermined model property is associated with one or more of: model weights, model activations, model gradients, model outputs, model metadata, or a combination of one or more of the above.

In some embodiments, machine learning model analyzer block 150 executes model analysis module 152 to determine a weight distance between each pair of models u and v in set M by analyzing uₗ and vₗ, denoting the weight matrix of layer l of models u and v respectively, using the equation

$${ℓ}_{FT} ( u , v ) = \frac{1}{L} {\sum }_{l = 1}^{L} {ℓ}_{2} ( {u}_{l} , {v}_{l} ) ,$$

where L is the number of model layers. In some embodiments, in the case of pairs of models trained based on LoRA, machine learning model analyzer block 150 executes model analysis module 152 to estimate the node distance between the pair of LoRA-trained models using the equation

$${ℓ}_{LoRA} ( u , v ) = {max}_{l} ( rank ( {u}_{l} - {v}_{l} ) ) ,$$

where L is the number of fine-tuned LoRA layers.

In some embodiments, at the conclusion of step 806, machine learning model analyzer block 150 executes model analysis module 152 to generate a pairwise distance matrix D representing the estimated distances between each pair of models in set M.

In step 808, machine learning model analyzer block 150 executes model analysis module 152 to designate each model within set M which is indicated as having undergone quantization q as a ‘leaf’ node, i.e., a model comprising no child model.

In step 810, machine learning model analyzer block 150 executes model analysis module 152 to check for duplicate models within set M, based on a pairwise distance between models as measured in step 806, wherein a pair of models are designated as duplicates when a distance between the pair of models is equal to zero or is below a specified threshold. In step 810, machine learning model analyzer block 150 executes model analysis module 152 to remove one of each pair of models so designated as duplicates.

In optional step 812, machine learning model analyzer block 150 executes model relationship analysis module 154 to connect pairs of models in set M with a directional edge indicating parent-child relationship, based on any available model parentage data P received in step 802.

In step 814, machine learning model analyzer block 150 executes model relationship analysis module 154 to iteratively predict a parent model P for each model m in set M.

Accordingly, machine learning model analyzer block 150 first executes model relationship analysis module 154 to apply a K nearest neighbor (KNN) algorithm to identify the K nearest neighbors of each model m in set M, based on a predetermined K value and input distance matrix D determined in step 806.

Machine learning model analyzer block 150 then executes model relationship analysis module 154 to determine iteratively, with respect to each model m in set M, whether it belongs to a ‘snake’ pattern or a ‘fan’ pattern (see FIG. 7B), based on the following rule:
When the distances of model m with respect to its K nearest neighbors (as indicated in matrix D) are correlated with their respective temporal distances (as determined in step 804), then model m is part of a snake pattern. This is because snake patterns arise from sequential training checkpoints, and thus the weight distance has high correlation with model creation/upload time.
Accordingly, when a correlation measure of (i) the weight distances of model m with respect to its K nearest neighbors, and (ii) their respective temporal distances, exceeds a predetermined threshold ρₜₕ, the K nearest neighbors are determined to be part of a ‘snake’ pattern.
When the distances of model m with respect to its K nearest neighbors (as indicated in matrix D) are uncorrelated with their respective temporal distances (as determined in step 804), then model m is part of a ‘fan’ pattern.

Thus, machine learning model analyzer block 150 executes model relationship analysis module 154 to connect model m with a directional edges to a predicted parent model in set m, based on the determination with respect to the pattern to which model m belongs to.

Accordingly, in the case of a K nearest neighbors group of model m determined as comprising a ‘snake’ pattern, machine learning model analyzer block 150 executes model relationship analysis module 154 to connect model m with an edge to its nearest model based on their weight distance, wherein a direction of the connecting edge is determined based on their respective temporal order, i.e., a nearest neighbor model with an earlier creation/upload date will be designated as a ‘parent’ in relation to model m, and vice versa, a nearest neighbor model with a later creation/upload date will be designated as a ‘child’ in relation to model m.

Accordingly, in the case of a K nearest neighbors group of model m determined as comprising a ‘fan’ pattern, machine learning model analyzer block 150 executes model relationship analysis module 154 to connect model m with an edge to its nearest neighbor model within K nearest neighbors group having the earliest creation/upload date as a ‘parent’ in relation to model m.

At the conclusion of step 814, at the conclusion of step 806, machine learning model analyzer block 150 executes model relationship analysis module 154 to generate a directional matrix representing the predicted parent model P for each model m in machine learning model set M.

In step 816, machine learning model analyzer block 150 executes model representation generator 156 to generate a structured visualization representation of machine learning model set M, based on the pairwise distance matrix D representing the estimated distances between each pair of models in set M, and the directional matrix representing the predicted parent model P for each model m in machine learning model set M.

### Experimental Results

The inventors created two experimental test datasets based on the “hub-stats” dataset (https://huggingface.co/datasets/cfahlgren1/hub-stats).

The first test dataset is used to test structured representation charting. It consists of 3 structured connected components (CCs): Qwen2.5-0.5B (Qwen), Llama-3.2-1B (Llama), and Stable-Diffusion-2 (SD). To construct the charting dataset, the inventors created a model graph of all models on Hugging Face, with ground truth edges between models that reference each other. All nodes with no parent or child were removed (i.e., CCs comprising only a single model), reducing the initial 1.3 million models to approximately 400,000 models across different connected components.

The second test dataset is used for testing attribute prediction and imputation over 6 attributes: accuracy, pipeline tag, library name, model type, license, and relation type, as well as model evaluation metrics. The ground truth was obtained by a combination of model metadata and running an LLM on the model cards. The attributes imputation dataset includes all 1.3 million models found on Hugging Face.

The inventors used the as baseline for comparison purposes a weight-agnostic classical method, as well as an implementation of method 500 herein. As detailed hereinabove, method 500 predicts edge direction using weight kurtosis and relies on the structure being a model tree. In addition, the following structure-only baselines were also included in the comparison: random edge assignment, majority vote (assigning all nodes to the parent with the highest out-degree), and Price's model, which is a preferential attachment algorithm used for citation networks, that assigns edge probabilities based on node out-degree. It is essentially a probabilistic version of majority vote that allows for new “hub” formation. Note that all baselines (except random), assume the structure is a model tree, not a DAG. To accommodate the majority vote and Price's models, the comparison assumed a graph stem with known edges, containing 10% of the nodes in the connected component. The inventors evaluated all methods by their accuracy on the remaining 90% of models

The present technique and the baseline methods were used to chart three structured representations of the three connected components in the test datasets. The baselines performed better than random but still poorly. The majority approach models the graph as depth-1 centered around the root. This obtains low but non-trivial results, as this model is too simplistic. Price's model is more powerful and can create a more realistic looking structure. However, it fails as it is data agnostic and connects the wrong nodes.

Table 3C below reports the structured representation test results. The present method outperforms the baselines by a significant margin, even for unknown models sets.

TABLE 3C

| METHOD | QWEN | LLAMA | SD |
|---|---|---|---|
| Random - root | 1.77 | 1.84 | 0.22 |
| Random | 0.98 | 0.67 | 0.75 |
| Majority Vote | 15.03 | 25.00 | 36.75 |
| Price's | 2.28 | 5.08 | 8.50 |
| Present method | 78.87 | 80.44 | 85.10 |

Table 4C below demonstrates that all components of the present method have value. The greedy method improves over the exact spanning tree algorithm as it allows to handle non-tree DAGs which include model merges, and find a valid solution. For example, the Edmonds' algorithm failed to return a result on the SD split as it did not find a valid tree. The quantization prior has a major effect for DAGs with many quantization near-duplicates, such as Llama (+44%). The fans and snakes prior improves all DAGs, especially in hub-like DAGs such as Stable-Diffusion (+13%).

In one test, the inventors ablate approximating the full weight distance with a subset of neurons, to test how subsampling the number of neurons affects the present model accuracy. Ablating to 100 neurons presents a good tradeoff between accuracy and computational cost, because it results in minimal accuracy loss while being 2 magnitudes computationally cheaper.

TABLE 4C
In the subtractive ablation test, the inventors remove each of the
assumptions detailed hereinabove individually. As can be seen, each
of the ablated assumptions contributes to the overall accuracy.

| METHOD | QWEN | LLAMA | SD |
|---|---|---|---|
| Greedy Algorithm | 77.34 | 78.98 | Failed |
| Quantization | 70.57 | 36.59 | 84.85 |
| Deduplication | 67.85 | 75.28 | 88.76 |
| Temporal | 75.47 | 80.13 | 80.86 |
| Consistency | | | |
| Fans vs. Snakes | 75.09 | 76.03 | 71.72 |
| Merges | 76.95 | 76.61 | 84.85 |
| Present Method | 78.87 | 80.44 | 85.10 |

### Machine Learning Model Classification Based on Weights

As noted above, the increasing availability of machine learning models in large repositories raises the need for a machine learning model trained on collections of underlying models, which will enable analyzing different aspects of a target model. Specifically, such ‘metanetwork’ may be trained on model weights of an underlying collection of models, with ground-truth labeling indicating the class categories used in training each model. Such trained metanetwork will then be able to predict the class categories used in the training dataset of a target unseen model, for example.

However, training a machine learning model on underlying model weights is challenging, as model weights often exhibit significant variation unrelated to each model's semantic properties, known as “nuisance variation.”

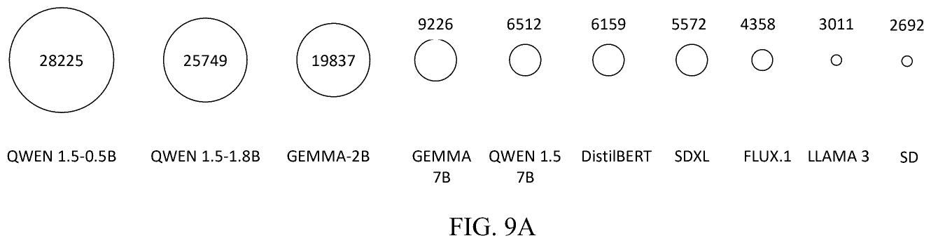

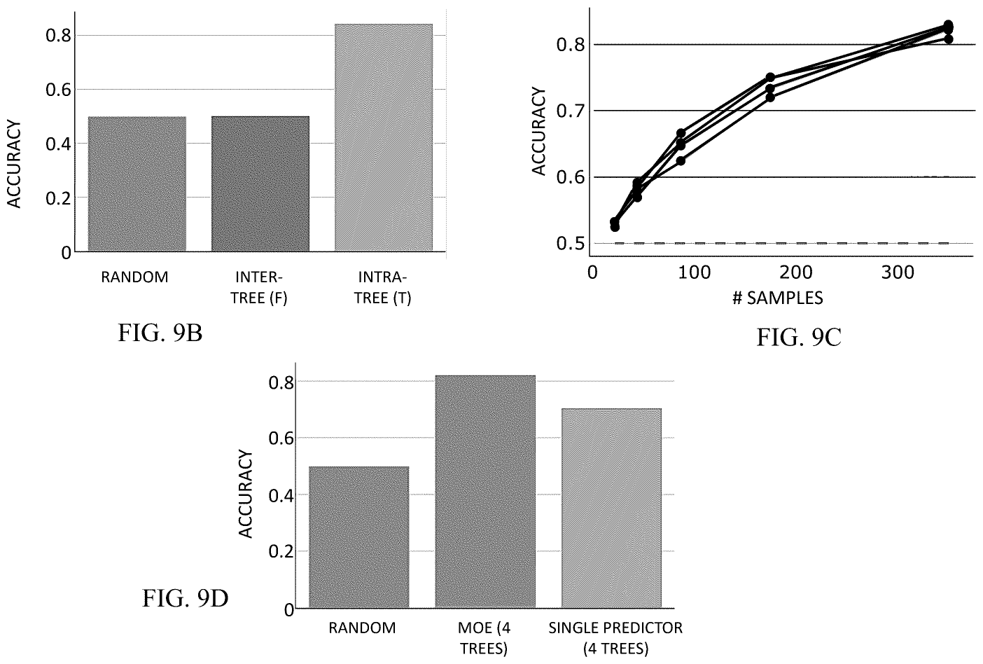

Accordingly, in some embodiments, the present technique is based on the insight that many models belong to model trees, where all models within a tree are fine-tuned from a common ancestor (a foundation model). A model tree describes a set of models that share a common ancestor (root), wherein each subsequent model is derived by specialized training (i.e., fine-tuning), from the root model or from one of its descendants. For example, the Llama3 (https://ai.meta.com/blog/meta-llama-3/) model tree includes all models fine-tuned from Llama3 or any of its descendants. In practice, most models in repositories belong to a relatively small number of model trees. For instance, on Hugging Face, fewer than 20 model trees cover most models. To explore the practicality of working within model trees, the inventors analyzed approximately 250 k models from the Hugging Face model hub. It was found that most models in repositories belong to a small number of large model trees. FIG. 9A shows model tree distribution of the 10 largest model trees on Hugging Face. These top 10 model trees account for 43.4 of all models currently on Hugging Face. Furthermore, 20 model trees cover 50% of the models, wherein the top 196 trees which contain 100 or more models, collectively cover over 70% of all models.

Thus, it may be argued that learning metanetworks within model trees is both effective and practical, and that, as shall be demonstrated below, learning an expert for each tree greatly simplifies weight space learning.

As noted above, the present technique is based, at least in part, on the insight is that learning model weights over a single model tree greatly simplifies weight space learning, as compared to learning from models across different trees. This is attributed to the fact that within each tree, there is less nuisance variation between the related models.

Consequently, learning within a single model tree requires much less complex architectures, wherein even a linear classifier trained on a single model layer often produces good results. However, linear classifiers, although effective, are computationally expensive, especially when dealing with larger models that have many parameters. For example, standard linear classifiers require too many parameters for learning on large models. To address this, the present technique provides for single layer probing model, a theoretically grounded architecture that scales weight space learning to large models. Unlike conventional probing methods, the present probing model operates on hidden model layers. Thus, the present probing model can handle models with hundreds of millions of parameters, while requiring only a short training period. In some embodiments, the present probing model is configured to predict the categories in a target model's training dataset, based only on analyzing the target model's weights.

In some embodiments, the present technique advances the field of weight space learning, which studies how to design and train ‘metanetworks,’ neural networks that take the weights of other neural networks as inputs, and trains a metanetwork to predict attributes of a target unseen model. Weight space learning covers learning representations of trained neural network models, to provide an understanding of the inner workings of those models. The “weight space” is a high-dimensional space representation of model parameters of a population of trained models, which allows to gain insights into the inner workings of those models. Weight space learning treats each model as a data point, and aims to train metanetworks that process weights of other models as inputs. The trained metanetwork can then predict categories in a model's training dataset.

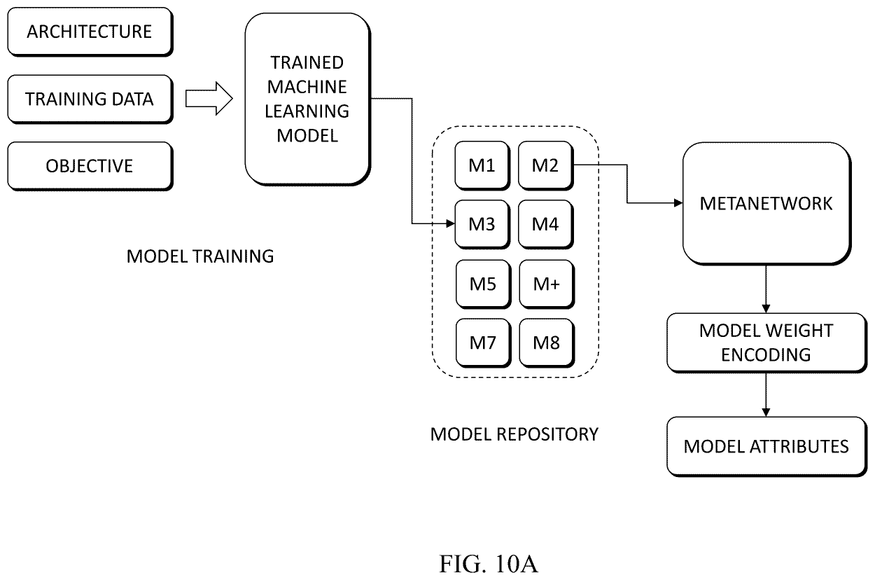

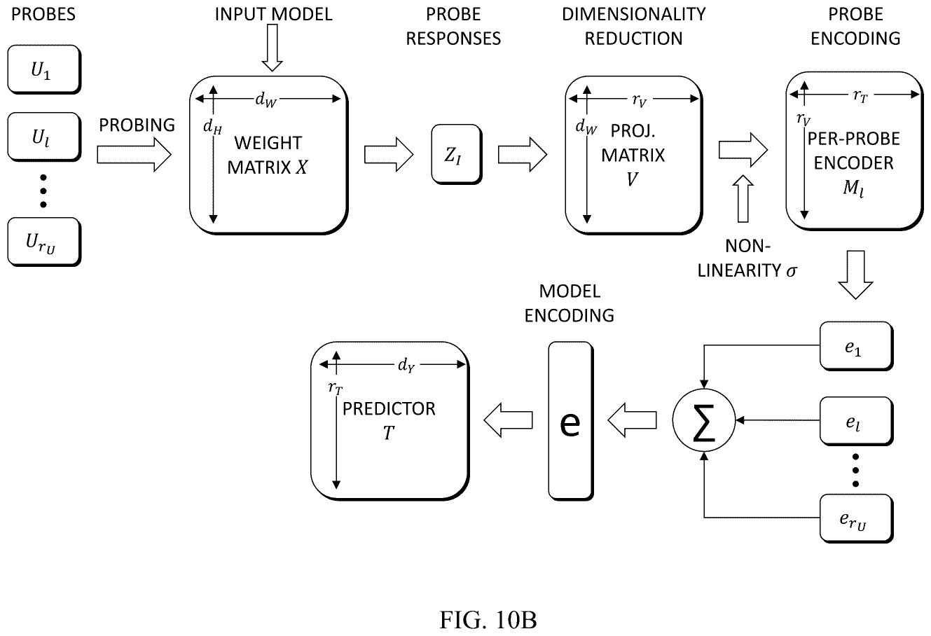

FIG. 10A depicts the pipeline of a process for training and implementing a probing expert model of the present technique. The present technique is based on the insight that model weights are a direct product of the training and optimization process, based on training data.

In some embodiments, the present technique provides for zero-shot model classification, where models are classified via a text prompt describing their training data. As used herein, “zero-shot” or “zero-shot learning” refers to a model is inferenced over samples from classes which were not observed during training, and is able to predict the class that they belong to.

However, extracting meaningful information from model weights is challenging. While the weights of a neural network are a function of its training data, they are also affected by the optimization process, which may introduce nuisance variation unrelated to attributes of interest. Neuron permutation is perhaps the most studied nuisance factor and has driven research into permutation-invariant architectures and carefully designed data augmentations. Another important nuisance factor is the weights at the beginning of optimization.

To evaluate the present technique, the inventors used a dataset of 14,000 models across 5 distinct model trees spanning multiple architectures and functionalities. The present technique achieved accurate results on the task of training category prediction, accurately identifying the specific classes within an unseen target model's training dataset. In addition, the present technique can also align fine-tuned Stable Diffusion weights with language representations. This capability enables a new task: zero-shot model classification, where models are classified via a text prompt describing their training data. On this task, the present technique achieves a 89.8% accuracy.

Although machine learning on images, text, and audio is fairly advanced, learning from model weights is still in its infancy, and the key nuisance factors remain unclear. Many approaches focused on neuron permutations as the core nuisance factor. However, permutations are not likely to describe all nuisance variation, as neurons and layers can serve different roles across models and architectures. This paper highlights that learning within model trees reduces nuisance variation, making learning simpler.

Machine learning model populations can be represented as a model graph comprising multiple model trees. In this representation, each node is a model, with directed edges connecting each model to those directly fine-tuned from it. Since a model has at most one parent, a model graph forms a set of non-overlapping trees. Importantly, although all the models within a model tree share the same architecture, two models with the same architecture but different roots belong to different model trees. For example, DINO and MAE both use the same ViT-B/16 architecture, but belong in distinct trees. Accordingly, the present technique uses model trees to group models with shared initial weights, thereby reducing nuisance variation.

Current weight space methods generally rely on a single metanetwork to learn from a diverse model population spanning multiple trees. The present technique hypothesizes that learning within a single model tree is significantly simpler than learning across multiple model trees. Thus, it may be expected that dividing the population into distinct model trees and learning within each tree can greatly simplify weight space learning.

In order to test this hypothesis, the inventors simulated various model populations. First, a dataset A was created by randomly selecting 50 classes from the CIFAR100 dataset (https://www.cs.toronto.edu/-kriz/cifar.html, a dataset comprising 100 classes, each containing 600 images), and a dataset B was created by randomly selecting 25 of the remaining classes from CIFAR100. A classifier was pre-trained on dataset B for a single epoch. Then two different model populations, each comprising 500 ResNet9 models are trained: model population T (where all models belong to a single model tree), and model population F (model forest, where the models belongs to multiple model trees). All models are trained to classify among 25 randomly selected classes from dataset A. The populations differ in one aspect only: models in F are initialized randomly, while models in T are all initialized from the same model pre-trained on B. Therefore, all models in T belong to the same model tree, while each model in F belongs to a different tree. Given a model, the task is to predict which 25 out of the 50 classes from A were used to train it. Using T and F, it is possible to analyze learning within and across model trees.

FIGS. 9B-9D show the result of this experiment, conducted by the inventors to illustrate the benefits of learning within model trees. In each experiment, a linear classifier is trained to predict the classes used to fine-tune train a target ViT-based model.

First, to test whether learning within the same model tree is beneficial, the inventors conducted an experiment by training a linear metanetwork for models in T and another one for models in F. In line with the underlying hypothesis, there is a large performance gap between the two settings. FIG. 8B shows a comparison in accuracy results between a metanetwork trained on models from the same tree (T) with one trained on models from different trees (F) and a random network. While learning on models within the same tree (intra-tree, T) achieved good accuracy results (0.844), learning on models from many different trees (inter-tree, F) achieved near random accuracy (0.502). This demonstrates that model tree membership introduces significant non-semantic variations in model weights, and that even a single epoch of shared pre-training might be enough to eliminate the variation.

Next, the inventors conducted an experiment to demonstrate positive transfer within the same model tree, by showing that adding more models from the same tree improves the performance. The graph in FIG. 8C shows results relating to models samples from four different model trees. As can be seen, increasing the number of samples from the same tree improves accuracy.

Conversely, as shown in Table 1A below, adding models from different trees degrades performance. The inventors trained and evaluated a metanetwork on models from T₁. Then models from other trees (T₂, . . . , T₄) were gradually added, to check whether training different metanetworks on these larger datasets improves the classification of models from T₁. As can be seen, adding models from different trees decreases the accuracy on T₁, demonstrating that learning from multiple trees has a negative transfer effect.

TABLE 1A
NEGATIVE TRANSFER BETWEEN TREES

| NUMBER OF TREES | NUMBER OF MODELS | ACCURACY |
|---|---|---|
| 1 | 350 | 0.844 |
| 2 | 700 | 0.752 |
| 3 | 1050 | 0.686 |
| 4 | 1400 | 0.724 |

Finally, the inventors compared learning a single joint metanetwork for all trees, versus combining multiple separate tree-specific metanetwork via a Mixture-of-Experts (MoE) approach. As can be seen in FIG. 8D, the MoE approach outperforms joint training.

FIG. 10B depicts a schematic overview of a probing model of the present technique. Unlike conventional probing methods that operate only on inputs and outputs, the present technique provides for a lightweight architecture which scales weight space learning to large models by probing hidden model layers. The present probing model begins by passing a set of learned probes u₁, u₂, . . . , uᵣ_{_{U}} through the weight matrix X of an input unseen model. A projection matrix V, shared among all probes, reduces the dimensionality of the probe responses, followed by a non-linear activation. Each probe response is then mapped to a probe encoding e₁ via a per-probe encoder matrix Mₗ. The probe encodings e₁, e₂, . . . , eᵣ_{_{U}} are then summed to obtain the final model encoding e, which the predictor head maps to the task output y.

Consider a model [symbol] with s layers and denote the dimension of each layer by d_{H} and d_{W}. (Higher-dimensional weight tensors, e.g., convolutional layers, are reshaped into 2D matrices, with the first dimension being the output channels). Let X⁽¹⁾, . . . , X^{(s)} denote the weight matrices of the layers. In practice, this method is applied to each layer of the model individually. In case the model uses LoRA specialization (i.e., fine-tuning), the decomposed matrices X=BA are multiplied, to obtain the full matrix. The goal may be defined as to map a weight matrix X∈ [symbol] ^{d}^{_{W}}^{×d}^{_{H}} to an output vector y∈ [symbol] ^{d}^{_{Y}}, where y is a logits vector in classification tasks or an external semantic representation in text alignment tasks.

Known metanetwork solutions rely on learning a separate model for each model tree (known as a dense expert). A simple choice for the architecture is a linear function. As the input is a 2D weight matrix X∈ [symbol] ^{d}^{_{W}}^{×d}^{_{H}}, the linear function is a 3D tensor W∈ [symbol] ^{d}^{_{H}}^{×d}^{_{W}}^{×d}^{_{Y}}. Formally,

$${y}_{k} = {\sum }_{i j} {W}_{i j k} {X}_{i j} \qquad ( 1 B )$$

Although such a dense expert can achieve good performance, its high parameter count (often exceeding 1 billion) makes it impractical due to excessive memory requirements.

A different approach is probing, which recently emerged as a promising approach for processing neural networks. Instead of directly processing the weights of the target model, it passes probes (i.e., input vectors) through the model and represents the model by its outputs. As each probe provides partial information about the model, fusing information from a diverse set of probes improves representation. Passing probes through the model is typically computationally cheaper than passing all the network weights through a metanetwork, making probing much more parameter efficient than the alternatives. Probing represents a model by running it on several fixed inputs and noting the responses received on them. The learner can then train a classifier to map the model responses to the label. This approach avoids the issue of weight permutation invariance as both the orders of input dimensions (e.g., image pixels) and output dimensions (e.g., class logits) are consistent across models.

Assuming that the objective is to predict an attribute y of a neural network ƒ, probing methods begin by optimizing a set of k probes (p₁, . . . , Pₖ), and feed them into the network ƒ. Then, a classifier C can be trained on the concatenation of the outputs. The prediction y\hat{ } is thus y\hat{ }=C(ƒ(p₁), ƒ(p₂), . . . , ƒ(Pₖ)). Probing methods learn the parameters of each probe p directly by latent optimization. Each probe provides some information about the model attributes, and learning diverse and discriminative probes is key for obtaining a useful representation. The classifier C leverages information from all probes, and is typically trained by cross-entropy for classification and mean squared error for regression.

In some embodiments, the present technique may be defined formally by an input function ƒₓ: [symbol] ^{d}^{_{W}}→R^{d}^{_{H}}, such as an unseen target neural network. The present method first selects a set of probes u₁, u₂, . . . , uᵣ_{_{U}}∈ [symbol] ^{d}^{_{W}} and passes each probe uₗ through the function ƒ_{X}, resulting in a probe response zₗ=ƒ_{X}(uₗ)∈ [symbol] ^{d}^{_{H}}. A per-probe encoder [symbol] ₗ then maps the response zₗ of each probe to encoding eₗ∈ [symbol] ^{d}^{_{H}}. The final model encoding e is the sum of the encodings of all probes:

$$e = {\sum }_{l} {ℰ}_{l} ( {f}_{X} ( {u}_{l} ) ) .$$

Finally, a prediction head [symbol] : [symbol] ^{d}^{_{V}}→ [symbol] ^{d}^{_{Y}}, maps the model encoding to the final prediction:

$$y = 𝒯 ( e ) \qquad ( 2 B )$$

### Single Layer Probing Model

Traditionally, probing methods focus only on model inputs and outputs, thus avoiding many nuisance factors (e.g., neuron permutations). However, as working within model trees reduces nuisance variation (as demonstrated above), the present technique provides for probing applied to hidden layers. Initially, the discussion will focus on the case where ƒ_{X}(u)=X(u) and probing encoders are linear.

In some embodiments, the present technique is based on the notion that linear probing can express any dense expert. Assume [symbol] ₁, . . . , [symbol] ᵣ_{_{U}} are all linear operations, and a sufficient number of probes. The dense expert (Equation (1B)) and linear probing model (Equation (2B)) have identical expressivity. It can be shown that the dense probing model entails linear probing (1), and that probing entails linear probing models (2). Direction (1) is trivial, as linear probing is a composition of linear operations, it follows that the operation is a linear operation from [symbol] ^{d}^{_{W}}^{×d}^{_{H}}→ [symbol] ^{d}^{_{Y}}. As the dense expert, parameterized as W∈R^{d}^{_{W}}^{×d}^{_{H}}^{×d}^{_{Y}}, can express all linear operations in [symbol] ^{d}^{_{W}}^{×d}^{_{H}}→R^{d}^{_{Y}}, it clearly entails linear probing. Direction (2) requires to prove that a set of matrices U, [symbol] [1], [symbol] [2], . . . , [symbol] [r_{U}], T can be found such that y=Σₗ [symbol] [l]Xuₗ=ΣᵢⱼWᵢⱼₖXᵢⱼ for every X∈ [symbol] ^{d}^{_{W}}^{×d}^{_{H}} and any W∈R^{d}^{_{W}}^{×d}^{_{H}}^{×d}^{_{Y}}. The proof can be shown by construction. Let T=I (the identity matrix), U=I and [symbol] [l]ᵢₖ=Wᵢₗₖ:

$${y}_{k} = ( T {\sum }_{l} ε [ l ] X {u}_{l} ) k = {\sum }_{ijl} {W}_{ilk} {X}_{i j} {δ}_{j l}$$

where δⱼₗ is 1 in the diagonal and 0 otherwise, the T is the identity matrix and cancels out. Summing over 1:

$${y}_{k} = {\sum }_{i j} {W}_{i j k} {X}_{i j} .$$

This proves that linear probing can express any dense expert.

Having demonstrated that the linear probing framework can match the expressivity of the dense expert, the primary issue of the dense approach can now be addressed: high parameter count. Recall that each of the r_{U} probes has a dedicated encoder, parameterized by a large matrix. Therefore, each probe encoder may be factorized into a product of two matrices. The first is a dimensionality reduction matrix V∈ [symbol] ^{d}^{_{W}}^{×r}^{_{V}} shared across probes. This matrix projects the high-dimensional outputs of X∈ [symbol] ^{d}^{_{W}}^{×d}^{_{H}} into a lower dimension r_{V}. The second matrix, Mₗ∈ [symbol] ^{r}^{_{V}}^{×r}^{_{T}} is unique to each probe encoder and can be much smaller. By sharing the larger matrix V among all probes and using a smaller, probe-specific matrix Mₗ, the overall parameter count is significantly reduced. Finally, the per-probe encoder is given by:

$${ℰ}_{l} ( {z}_{l} ) = {M}_{l} {V}^{T} {z}_{l} \qquad ( 3 B )$$

The prediction head [symbol] is simply the matrix T∈ [symbol] ^{r}^{_{T}}^{×d}^{_{Y}}. Putting everything together, the present single layer probing model is:

$$y = T {\sum }_{l} {M}_{l} {V}^{T} {X}^{T} {u}_{l} \qquad ( 4 B )$$

Equation (4B) has identical expressivity as using the dense predictor of Equation (1B), when the weight tensor W obeys the Tucker decomposition:

$${W}_{T u cker} = {\sum }_{n m l} {M}_{n m l} \cdot {t}_{n} ⊗ {v}_{m} ⊗ {u}_{l}$$

This can be proven based on the Tucker decomposition, which expresses a 3D tensor W∈ [symbol] ^{d}^{_{W}}^{×d}^{_{H}}^{×d}^{_{Y}} by the product of a smaller tensor M∈ [symbol] ^{r}^{_{T}}^{×r}^{_{V}}^{×r}^{_{U}} and three matrices U∈ [symbol] ^{d}^{_{H}}^{×r}^{_{U}}, V∈ [symbol] ^{d}^{_{W}}^{×r}^{_{V}}, T∈ [symbol] ^{d}^{_{Y}}^{×r}^{_{T}} as follows:

$$W = {\sum }_{n m l} {M}_{n m l} \cdot {t}_{n} ⊗ {v}_{m} ⊗ {u}_{l}$$

where ⊗ is the tensor product, and u_{q}, v_{q}, t_{q} are the q^{th} column vectors of matrices U, V, T respectively.

The expression for the Tucker decomposition in index notation is:

$${W}_{i j k} = {\sum }_{n m l} {T}_{k n} {M}_{n m l} {V}_{i m} {U}_{j l} .$$

By linearity, the sums can be reordered as:

$${W}_{i j k} = {\sum }_{n} {T}_{k n} {\sum }_{m l} {M}_{n m l} {V}_{i m} {U}_{j l}$$

Equivalently, tensor M can be split into r matrices M[1], M[2], . . . , M[r], so that:

$${W}_{i j k} = {\sum }_{n} {T}_{k n} {\sum }_{m l} {M [ l ]}_{n m} {V}_{i m} {U}_{j l}$$

Multiplying tensor W by input matrix X∈ [symbol] ^{d}^{_{W}}^{×d}^{_{H}}, the result is:

$${\tilde{y}}_{k} = {\sum }_{i j} {X}_{i j} {W}_{i j k} = {\sum }_{i j} {X}_{i j} {\sum }_{n} {T}_{k n} {\sum }_{m l} {M [ l ]}_{n m} {V}_{i m} {U}_{j l}$$

By linearity, the sums can be reordered:

$${\tilde{y}}_{k} = {\sum }_{n} {T}_{k n} {\sum }_{m l} {M [ l ]}_{n m} {\sum }_{l j} {V}_{im} {X}_{i j} {U}_{j l}$$

Rewriting U using its column vectors this becomes:

$${\tilde{y}}_{k} = {\sum }_{n} {T}_{k n} {\sum }_{m l} {M [ l ]}_{n m} {\sum }_{i} {{V}_{i m} ( X {u}_{l} )}_{i}$$

Rewriting the sum over i as a matrix multiplication:

$${\tilde{y}}_{k} = {\sum }_{n} {T}_{kn} {\sum }_{m l} {M [ l ]}_{n m} {( {V}^{T} {Xu}_{l} )}_{m}$$

Rewriting the sum over m as a matrix multiplication:

$${\tilde{y}}_{k} = {\sum }_{n} {T}_{kn} {\sum }_{l} {( M [ l ] {V}^{T} {Xu}_{l} )}_{n}$$

Rewriting the sum over n as a matrix multiplication, to obtain:

$$\tilde{y} = T {\sum }_{l} M [ l ] {V}^{T} {Xu}_{l}$$

In some embodiments, the present technique derives the present linear probing model (Equation (4B)) from the dense expert (Equation (1B)), using the Tucker tensor decomposition. The linear probing model (Equation (4B)) has identical expressivity as using the dense predictor (Equation (1B)), when the weight tensor W obeys the Tucker decomposition:

$${W}_{Tucker} = {\sum }_{nml} {M}_{nml} \cdot {t}_{n} ⊗ {v}_{m} ⊗ {u}_{l}$$

As shown hereinabove, the relation between linear probing model and the dense expert can be shown. To make probing model more expressive, a non-linearity a may be added between the two matrices V, Mₗ, making probing model a factorized one hidden layer neural network:

$${ε}_{l} ( {z}_{l} ) = {M}_{l} σ ( {V}^{T} {z}_{l} ) .$$

Based on experimentation, the inventors selected σ to be the ReLU function. Note that the approach can easily be extended to deeper probe encoders. An overview of probing model is shown in FIG. 10B.

For classification tasks, the present probing model may be used to map model weights to logits via the cross-entropy loss. For representation alignment, a contrastive loss may be used. In all cases, V, u₁, . . . , uᵣ_{_{U}}d, M₁, . . . , Mᵣ_{_{U}}, T are optimized end-to-end. Note that while the present formulation describes the case of a single layer, there is no loss of generality. Given multiple layers, an encoding may be extracted from each layer using probing model, wherein the encodings can then be concatenated. Finally, the concatenated encodings are mapped to the output y using a matrix T, training everything end-to-end. Notably, training probing model on a single layer takes under 10 minutes on a single small GPU (e.g., 10 GB of VRAM).

In practice, models may belong to multiple model trees. Therefore, in some embodiments, the present technique provides for a mixture-of-tree probing model (MoE) approach, consisting of a router metanetwork that maps models to their tree and a per-tree probing model. Differently from recent MoE methods that learn the router and probing models end-to-end, herein the two are decoupled: first learning the routing function and then the probing models. For the routing function, a fast and simple clustering algorithm may be used. Specifically, the set of models may be clustered into trees using hierarchical clustering. After completing the clustering step, the center of each cluster may be computed \hat{X}₁,\hat{X}₂, . . . , \hat{X}ₖ. The routing function assigns models to the nearest cluster in [symbol] ₂:

$$R ( X ) = arg {min}_{k} {‖ X - {\hat{X}}_{k} ‖}_{2} \qquad ( 5 B )$$

In practice, these clusters perfectly match the division into model trees.

To implement the routing function, hierarchical clustering is performed on the l₂ pairwise distances between models in the model graph. By calculating distances for a single model layer, this stage is significantly accelerated, enabling the algorithm to cluster model graphs with up to 10,000 models in under 5 minutes. Once clustering is complete, the routing function assigns each model to the nearest cluster based on l₂ distance. The number of model trees is determined using the dendrograms produced by hierarchical clustering.

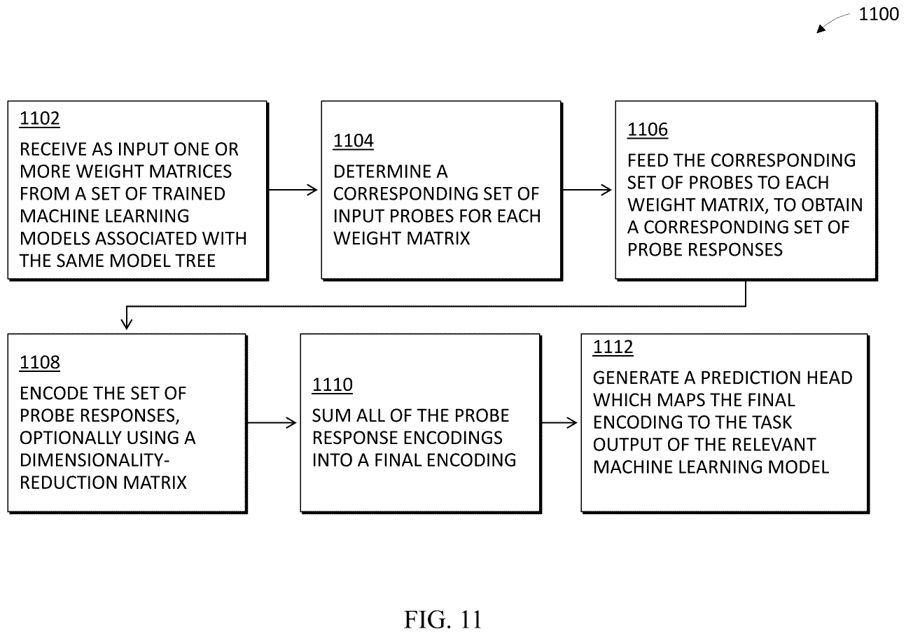

With reference back to FIG. 1, the instructions of machine learning model analyzer block 150 are now discussed with reference to the flowchart of FIG. 11, which details the functional steps in a method 1100 for training a probing model configured to predict the class categories used in the training dataset of a target unseen model within a specified model tree.

In some embodiments, the task of the present probing model is to map a weight matrix X∈ [symbol] ^{d}^{_{W}}^{×d}^{_{H}} to an output vector y∈ [symbol] ^{d}^{_{Y}}, where y is a logits vector in classification tasks, or an external semantic representation in text alignment tasks.

Steps of method 1100 may either be performed in the order they are presented or in a different order (or even in parallel), as long as the order allows for a necessary input to a certain step to be obtained from an output of an earlier step. In addition, the steps of method 1100 are performed automatically (e.g., by computing system 100 of FIG. 1, or by any other applicable component of computing environment 100), unless specifically stated otherwise.

Method 1100 begins in step 1102, wherein machine learning model analyzer block 150 receives, as input, one or more weight matrices X⁽¹⁾, . . . , X^{(s)}, associated with layers in one or more trained machine learning models within a specified model tree (i.e., where all models within the model tree are fine-tuned from a common ancestor, e.g., a foundation model). Each input weight matrix X∈ [symbol] ^{d}^{_{W}}^{×d}^{_{H}} represents a layer in a trained machine learning model which may be represented by the function ƒ_{X}: [symbol] ^{d}^{_{W}}→R^{d}^{_{H}}.

In step 1104, machine learning model analyzer block 150 executes model analysis module 152 to determine a set of probes u₁, u₂, . . . , uᵣ_{_{U}} which are configured to be employed as inputs to each input weight matrix. In some embodiments, the set of probes is optimized for each input weight matrix with a suitable optimization method. However, in some embodiments, the set of probes is sampled from simple, unlearned statistical distributions.

In step 1106, machine learning model analyzer block 150 executes model analysis module 152 to feed the set of probes u₁, u₂, . . . , uᵣ_{_{U}} into each input weight matrix, to obtain a corresponding set of probe responses zₗ=ƒ_{X}(uₗ)∈ [symbol] ^{d}^{_{H}}.

In step 1108, machine learning model analyzer block 150 executes model analysis module 152 to apply a per-probe encoder [symbol] ₗ then maps the responses zₗ of each probe in the set of probes to encoding e₁∈ [symbol] ^{d}^{_{V}}.

Optionally, machine learning model analyzer block 150 executes model analysis module 152 to factorize each probe encoder [symbol] ₗ into a product of two matrices: (i) a dimensionality reduction matrix V, V∈ [symbol] ^{d}^{_{W}}^{×r}^{_{V}}, shared across probes which projects the high-dimensional outputs of X∈ [symbol] ^{d}^{_{W}}^{×d}^{_{H}} into a lower dimension r_{V}, and (ii) a second matrix Mₗ, Mₗ∈ [symbol] ^{r}^{_{V}}^{×r}^{_{T}} that is unique to each probe encoder. By applying the shared larger matrix V among all probes, and using a smaller probe-specific matrix Mₗ, the overall parameter count is significantly reduced. In this variation, the per-probe encoder is given by: [symbol] ₗ(zₗ)=MₗV^{T}zₗ.

Optionally, a non-linear activation a may be added between the two matrices V, Mₗd, making the probing model a factorized one hidden layer neural network [symbol] ₗ(zₗ)=M₁σ(V^{T}zₗ). In some embodiments, a may be selected to be the ReLU function.

In step 1110, machine learning model analyzer block 150 executes model analysis module 152 to sum all of the encodings of all probes into a final weight matrix encoding e, e=Σₗ [symbol] ₗ(ƒ_{X}(u₁)).

In step 1112, machine learning model analyzer block 150 executes machine learning classifier 158 to generate a prediction head [symbol] : [symbol] ^{d}^{_{V}}→ [symbol] ^{d}^{_{Y}}, which maps the encoding of each input weight matrix into a final representation of the input weight matrix y= [symbol] (e).

In the case where the optional step of factorization of each probe encoder [symbol] ₗ as described above with reference to step 1108, the prediction head [symbol] is the matrix T∈ [symbol] ^{r}^{_{T}}^{λd}^{_{Y}}, and maps the encoding of the input machine learning model into a final prediction y=T Σₗ MₗV^{T}X^{T}uₗ.

In some embodiments, the trained probing model is configured to predict the training dataset classes of an unseen target machine learning model belonging to the same specified model tree. For example, the trained probing model is configured to predict whether a particular class in a set of classes was included in the target model's training data.

In some embodiments, method 1100 may be adapted to train the probing model, based on the notion that the weights of models conditioned on text can be aligned with a text representation of their class categories. Accordingly, in some embodiments, method 1100 may be adapted to further learn a mapping between the input weights matrices and text embeddings of their associated training dataset categories, using supervised learning based on known class categories for each weight matrix.

This training process uses text embeddings that are extracted for each class name, and the probing model is trained to encode the weight matrix X into a shared weight-text embedding space, where the optimization objective is to maximize the cosine similarity between the (i) probing model encoding as detailed with reference to the various steps of method 1100 and (ii) text embeddings of the ground-truth class categories of the weight matrix. This process creates a shared weight-text embedding space.

This adaptation of method 1100 creates a probing model configured to classify an unsee target model by using a text prompt similar to the model weight representation e using cosine similarity. This creates a zero-shot setting, where model weights from unseen classes are classified via text prompts.

### Experimental Results

The inventors constructed Model-J, a dataset that simulates the structure of real-world model repositories, with models organized into a small set of distinct model trees. These trees consist of large models that vary in architecture, task, and size, with each fine-tuned model using a set of randomly sampled hyperparameters. Model-J includes 14,000 models, divided into two main subsets:
Discriminative: The inventors fine-tuned 4,000 discriminative models for image classification. These models belong to one of 4 model trees:
   Supervised ViT.
   DINO.
   MAE.
   ResNet-101.
Each model is fine-tuned (using full fine-tuning) to classify images from a random subset of 50 out of the 100 CIFAR100 classes.
Generative: The inventors fine-tuned 10,000 Stable Diffusion (SD) personalized models. Each model was fine-tuned on 5-10 images, randomly sampled without replacement, originating from the same ImageNet class. This subset consists of 2 variants each with 5,000 models:
   SD₂₀₀. A fine-grained variant with 25 models from each class using the first 200 ImageNet classes (mostly different animal breeds).
   SD₁ₖ. A low resource variant with 5 models per class for all ImageNet classes.
The inventors used LoRA fine-tuning. An additional test subset of models trained on randomly selected holdout classes was set aside, comprising 30 classes form SD₂₀₀ and 150 classes from SD₁ₖ.

Both Model-J subsets were split into 70/10/20 for training, validation, and testing. Given the significant variation in results between layers, the present probing model was trained for 500 epochs on each layer, wherein the best layer and epoch are selected based on the validation set. The Adam optimizer was used with a weight decay of 1e-5 and a learning rate of 1e-3. The number of probe dimensions and encoder dimension are set to r_{U}=r_{V}=r_{T} 128.

The inventors selected the following reference models for comparison purposes:
StatNN: (see Thomas Unterthiner, et al. Predicting neural network accuracy from weights. arXiv preprint arXiv:2002.11448, 2020). This permutation-invariant reference extracts 7 simple statistics (mean, variance, and 5 different quantiles) for the weights and biases of each layer in a target model. It then trains a gradient-boosted tree on the concatenated statistics.
Dense Expert: (Equation (1B) above) Training a single linear layer on the flattened raw weights. Note that this reference produces impractically large classifiers. E.g., a single layer classifier trained to classify SD₁ₖ typically has 1.4B parameters, twice the size of the entire SD model.

In a first experiment, the inventors trained a probing model of the present technique as well as a dense expert and the reference models, to predict the training dataset classes for models in the discriminative subset of Model-J. in each case, the training was performed on 50 randomly selected classes out of 100, and the output is a set of 100 binary label predictions, each indicating whether a specific class was included in the particular model's fine-tuning data. Concretely, the models were trained using Equation (3B) with 100 jointly optimized binary classification heads. This task is particularly challenging, as each class represents only 2% of each model's training data, making its signature relatively weak.

This task is quite practical, however. Consider a model repository such as Hugging Face, which currently relies on the model metadata (e.g., model card) when searching for a model. However, these model cards are often poorly documented and lack details about the specific classes a model was trained on. In contrast, the present metanetwork could allow users to filter for suitable models more effectively.

Table 1A below presents the results of the present probing model, dense expert, and reference models, for each model tree in the discriminative subset. While dense expert performs better than random, the present probing model performs significantly better, improving accuracy by more than 10% on average with roughly ×30 fewer parameters. The MoE router (Equation (5B)) achieves perfect accuracy.

TABLE 1A
Training dataset class prediction results. Each model in the
target dataset was trained on 50 randomly selected CIFAR100
classes (out of a total of 100). The present probing model
and reference models are trained to predict which of the 100
classes were used during training. While the dense expert
performs moderately well, the present probing model achieves
better accuracy with roughly ×30 fewer parameters.

| | ResNet | | | DINO | | | MAE | | |
|---|---|---|---|---|---|---|---|---|---|
| Method | Acc. | #Paras. | | Acc. | #Paras. | | Acc. | #Paras. | |
| Random | 0.5 | — | | 0.5 | — | | 0.5 | — | |
| StatNN | 0.631 | — | | 0.511 | — | | 0.502 | — | |
| Dense | 0.713 | 105 | m | 0.614 | 59 | m | 0.666 | 59 | m |
| Present | 0.842 | 2.3 | m | 0.705 | 2.3 | m | 0.765 | 2.3 | m |
| probing | | | | | | | | | |
| model | | | | | | | | | |

| | |
|---|---|
| Sup. ViT | MOE |

| Method | Acc. | #Paras. | | Acc. | #Paras. | |
|---|---|---|---|---|---|---|
| Random | 0.5 | — | | 0.5 | — | |
| StatNN | 0.522 | — | | 0.541 | — | |
| Dense | 0.663 | 105 | m | 0.664 | 59 | m |
| Present | 0.885 | 2.3 | m | 0.79 | 2.3 | m |
| probing | | | | | | |
| model | | | | | | |

The inventors then conducted a test aimed at aligning the weights of models conditioned on text with a text representation. In this test, the present technique is used to learn a mapping between the weights of models in the generative subset and the CLIP (https://openai.com/index/clip/) text embeddings of the model's training dataset categories. CLIP is a multimodal vision and language model which learns about images directly from text, by jointly training on image, text pairs. This pretraining enables zero-shot transfer to downstream tasks. CLIP uses an image encoder and text encoder to get visual features and text features. Both features are projected to a latent space with the same number of dimensions and their dot product gives a similarity score.

This process creates a shared weight-text embedding space. These aligned representations are evaluated across various tasks and demonstrate strong generalization. Accordingly, the inventors trained the present probing model to map model encodings to pre-trained text embeddings (e.g., CLIP). This mapping is supervised, as there exist paired data consisting of (i) model weights and (ii) text embedding of the category of their fine-tuning dataset. The training loss is similar to CLIP, i.e., the optimization objective is that the cosine similarity between the present probing model encoding to the ground truth class text embedding will be high, and all other classes lower.

The inventors then tested the zero-shot capabilities of the aligned representation on the holdout subsets of Model-J.

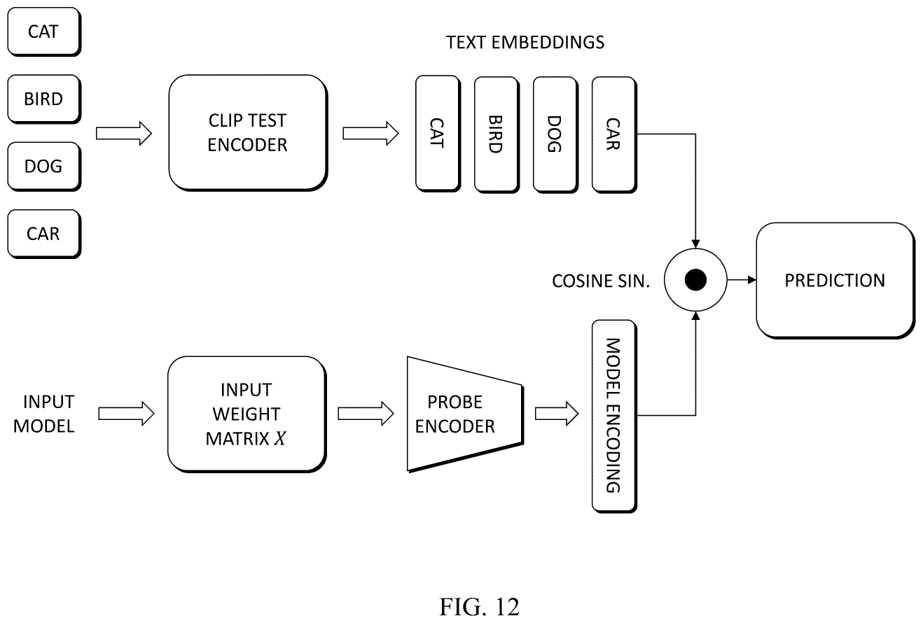

FIG. 12 shows schematically a zero-shot inference overview according to the present technique. Model weights are aligned with a pre-trained text encoder for zero-shot model classification. CLIP text embeddings are extracted for each class name, and the present probing model is used to encode the weight matrix X into a shared weight-text embedding space. Classification follows by selecting the text prompt nearest to the model weight representation e using cosine similarity. This creates a CLIP-like zero-shot setting, where model weights from unseen classes are classified via text prompts. Specifically, given a weights-to-text mapping function, the similarity between the model encoding and all possible classes was computed. The similarity score is calculated for all holdout classes (unseen during the present probing model's training), and the model is labeled with the class that has the highest matching score (see FIG. 12). A similar experiment is performed for in-distribution data (categories seen during training), i.e., a standard classification setting. Table 2A below shows the top-1 accuracy of the present method compared to the dense expert. Importantly, the present method generalizes not only to unseen models trained on the same classes (i.e., in-distribution) but also to entirely new object categories (i.e., zero-shot). The present probing model detects classes unseen during training with 50% accuracy when there are 150 held-out classes, and nearly 90% accuracy with 30 held-out classes. This demonstrates that the present probing model successfully aligns model encodings with CLIP's representations.

Table 2A: Table 2A shows the text-guided classification accuracy on both the in-distribution and holdout splits. The present method generalizes not only to unseen models trained on the same classes (in-distribution), but also to entirely new object categories in a zero-shot manner, without requiring additional training. This suggests that the present probing model successfully aligns model encodings with CLIP representations.

| | | In-Distribution | Zero-Shot | # of |
|---|---|---|---|---|
| | Method | Accuracy | Accuracy | Parameters |
| SD₂₀₀ | Random | 0.006 | 0.033 | — |
| | StatNN_{MLP} | 0.018 | 0.075 | 2.6m |
| | StatNNLinear | 0.030 | 0.147 | 689k |
| | Dense | 0.801 | 0.706 | 32m |
| | Present probing | 0.973 | 0.898 | 2.5m |
| | model | | | |
| SD₁ₖ | Random | 0.001 | 0.006 | — |
| | StatNN_{MLP} | 0.001 | 0.029 | 2.6m |
| | StatNNLinear | 0.010 | 0.045 | 689k |
| | Dense | 0.382 | 0.343 | 210m |
| | Present probing | 0.296 | 0.505 | 2.5m |
| | model | | | |

Similarly to the zero-shot setting, using the aligned representations, k-nearest neighbors (kNN) algorithms can correctly classify the training dataset class. The score is the average kNN distances between the text aligned the present probing model representation of the test model and the training models from this class. Table 3A below compares the aligned representation achieved by the present method with simply using raw weights, wherein the present method performs better.

The inventors further examined text-aligned representations for detecting out-of-distribution (OOD) models (one-class-classification, OCC). In this test, each holdout class is labeled as “normal,” and the average kNN distance between all test models and the training set of the normal class is computed. Samples near the normal distribution are considered normal while others are labeled as OOD. The results are averaged over all classes. Table 3A below reports the mean ROC AUC score, using the kNN similarity score for separating normal and OOD models. The results show that the present method can detect OOD models much more accurately than other methods. This result remains consistent across varying numbers of neighbors, clearly demonstrating that the representation extracted by the present probing model captures more semantic relations.

Table 3A: Table 3A shows kNN and OCC average results over all 30 holdout classes of SD200. The present probing model achieves the highest results for both.

| | kNN (Accuracy) | | | OCC (mAUC) | | |
|---|---|---|---|---|---|---|
| | | | Present | | | Present |
| | | | probing | | | probing |
| K | Raw | Dence | model | Raw | Dence | model |
| 1 | 0.833 | 0.502 | 0.913 | 0.501 | 0.561 | 0.398 |
| 2 | 0.389 | 0.525 | 0.933 | 0.502 | 0.573 | 0.702 |
| 5 | 0.417 | 0.477 | 0.872 | 0.504 | 0.910 | 0.720 |
| All | 0.033 | 0.294 | 0.428 | 0.507 | 0.681 | 0.792 |

The inventors then conducted a test comprising searching for models that were trained on the most similar datasets as a given model. The cosine distance between the present probing model text-aligned model representations was used as the similarity metric. In this test, for each query model, there was conducted a search for models trained on the most similar categories, measuring similarity via the cosine distance between the text-aligned present probing model representations. The retrieved models were closely related to the query models, showing that the present representation captures highly semantic attributes even in fine-grained cases. For instance, SD200 contains many different dog and cat breeds, however, the retrieval accurately returns the breed that the query model was trained on. This

The inventors further ablated the need for a non-linear present probing model using the SD₂₀₀ dataset (results are shown in Table 4A below). Interestingly, while the use of ReLU slightly improves in-distribution classification performance (0.953 without vs. 0.973 with), the main benefit is in zero-shot capabilities (0.564 without vs. 0.898 with). This significant difference in zero-shot performance suggests that, while the linear version of the present probing model can effectively represent the training classes, generalizing to unseen classes requires a deeper model.

Table 4A: Table 4A shows the results of activation ablation on SD₂₀₀. Using ReLU slightly improves in-distribution classification, but significantly improves zero-shot classification. This suggests that while linear present probing model represents training categories well, ReLU enhances generalization.

| | In-Distribution | Zero-Shot |
|---|---|---|
| | Accuracy | Accuracy |
| No ReLU | 0.953 | 0.564 |
| ReLU | 0.973 | 0.898 |

The inventors further used SD₂₀₀ to ablate the sensitivity of the present method to the precise language encoder used. While CLIP performs best (0.898), the present approach remains effective across different text encoders (e.g., 0.860 with OpenCLIP, and 0.564 with BLIP2), see for more details.

### Retrieving Classification Models Based On Target Concept

Neural networks have revolutionized fields like computer vision and natural language processing, becoming indispensable tools for many real-world classification tasks. However, the high training cost of neural networks leaves users with two suboptimal options: (i) invest heavily in computational resources for training or fine-tuning a model, (ii) settle for a general-purpose model that may not optimally suit the task.

Accordingly, the present technique provides for the ability to search within model repositories for a model suitable to perform a specified task. With the rise of large public and proprietary enterprise model repositories, this search ability is highly practical. For instance, Hugging Face, the largest existing model repository, hosts over 1 million models, with more than 100,000 models added monthly. This significantly increases the likelihood of finding a suitable model for most user tasks. The main challenge, however, lies in retrieving the right model for each task. While current model search methods rely on provided metadata or text descriptions associated with each model, most models in practice lack proper documentation or have very limited descriptions, which severely limits the ability of these search methods to retrieve suitable models.

FIG. 12 shows schematically the classification model search, where the goal is to find classifiers that can recognize a target concept. Concretely, given an input prompt, such as “Dog,” the search retrieves all classifiers that one of their classes is “Dog.” The search space is a large model repository that contains many models and concepts to search from. The retrieved models can replace model training, increasing accuracy, reducing cost and environmental impact.

In some embodiments, the present technique provides for searching for new models based on their weights, without assuming access to their training data or metadata, as these are often unavailable. More precisely, the goal is to retrieve all classification models capable of recognizing a particular concept, such as “Dog.” For a solution to be effective and practical, it must meet several requirements: (i) identifying models that recognize the target concept regardless of the other concepts they can detect, (ii) being invariant to model output class order, (iii) scaling to large model repositories, and (iv) supporting text-based search. Using a single representation to describe models is suboptimal for this task, as the target concept may only account for a small part of the representation. Model-level representations are often overly large, suffer from permutation variation and may be insensitive to the target concept.

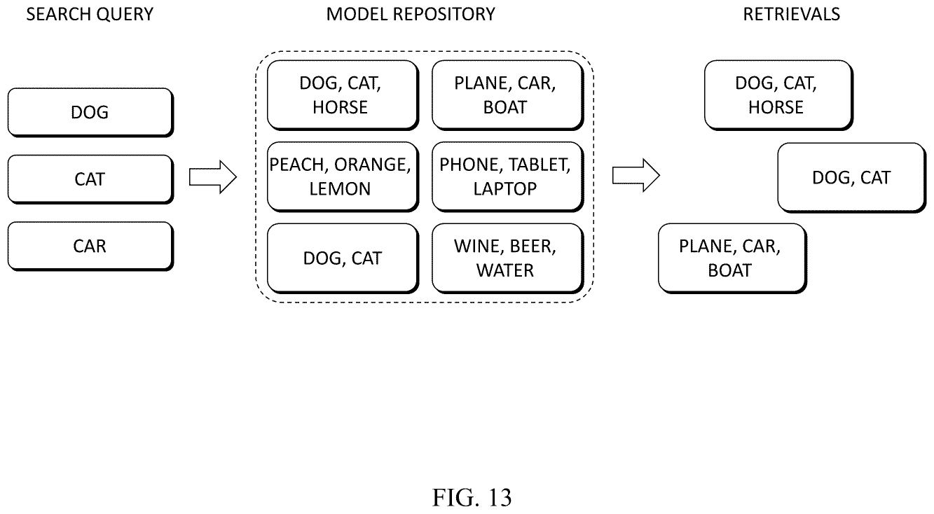

Accordingly, in some embodiments, the present technique provide for a probing-based logit-level descriptor especially designed for model search. Since the goal is to identify a functional property of the model (what it does), the descriptor is a functional representation, which essentially describes what the logit does. To compute the present probing descriptor for a specific logit in a given model, first the model is queried with a fixed set of pre-determined input samples (probes), and then its responses are observed in the specific output dimension. By normalizing the response vector across all probes, it is possible to obtain the present probing descriptor. Its dimension is equal to the number of probes. An illustration of probing descriptors is provided in FIG. 13. As can be seen, the present technique generates a descriptor for individual output dimensions (logits) of models. First, a set of inputs (e.g., from the COCO dataset) are sampled as a set of probes. The probes are fed into an input model, and their outputs are observed. Finally, the values of the logit to be represented are normalized and used to accurately retrieve model logits associated with similar concepts. Crucially, unlike prior methods for analyzing neural network weights, the present approach represents logits rather than the models themselves, which are more suitable for search.

The present probing representations enable searching by logit (“more like this”), however it does not provide searching for unseen concepts (“find models that recognize ‘dogs’”).

Accordingly, in some embodiments, the present technique provides for using a text alignment model (e.g., CLIP) between the probes and target concept name, to compute a zero-shot probing representation. After suitable domain normalization, this approach achieves accurate zero-shot search.

In some embodiments, the present technique further provides for collaborative probing, a method to significantly reduce the cost of creating representations for a whole repository of models. Under collaborative probing, instead of probing all models with all probes, the present technique uses a random selection of the probes for each model. The missing information is then completed with matrix-factorization based collaborative filtering. This results in greatly improved performance for low probe numbers.

The inventors tested the present probing descriptor's effectiveness on two real-world datasets: one based on models trained by the inventors, and the other containing models obtained from Hugging Face. The present method is scalable and can handle large models with high effectiveness and efficiency. It achieves high retrieval accuracy, reaching over 40% top-1 accuracy when predicting whether a model can recognize an ImageNet target concept from text. As the retrieval accuracy of a random method only scores 0.1% (since there are 1,000 possible classes), the present method's performance is significant.

### Problem Definition: Model Search

Assume a model repository composed of m classifiers, ƒ₁, ƒ₂, . . . , ƒₘ. Each classifier ƒᵢ can have multiple output dimensions (logits), and each corresponding to an unknown concept c_{i,j}. The user then inputs a text prompt containing some query concept, c_{q}, they wish to search for. Finally, the goal is to return a model ƒᵢ such that one of its classes matches the query concept. Formally, the set of all valid retrieval models, R(c_{q}), is defined as:

$$R ( {c}_{q} ) = \{ {f}_{i} \vert ∃ j s . t . {c}_{i , j} = {c}_{q} \} \qquad ( 1 C )$$

As mentioned above, the retrieval algorithm does not know the class concepts of each model.

While a trivial solution is to create model-level representations, this idea encounters serious setbacks. First, representing models by their weights is difficult and computationally expensive due to their high dimensionality and complex symmetries. Second, encoding an entire model is not suitable for functionality-based search. To illustrate, consider a classifier that separates between “Dog” and “Cat” and another model for “Dog” and “Lion.” Despite both including the target concept “Dog,” each model will have a different encoding. Moreover, even classifiers with identical classes that are ordered differently (“Dog”-“Cat” vs. “Cat”-“Dog”) may produce distinct representations. To overcome this limitation and ensure invariance to other detected classes and their order, the present provides for a separate descriptor (representation) for each output dimension of each model.

The existing solution for model search is text-based search in the documentation associated with the model. To understand the effectiveness of this solution, the inventors explored the level of documentation of models in Hugging Face. For that, the inventors analyzed all 1.2M model cards. Over 30% of all models have no model card at all. Moreover, there are another 28.9% of model cards that are either empty or include an empty automatic template with no information. The remaining 40% of model cards may include some information, however, it is not immediately clear how many of those include relevant information about the training data.

### Logit-Level Descriptors

The present technique provides for accurately and efficiently searching for relevant models in a large repository, based on a target concept, e.g., a target classification category for which the model was trained, such as “Dog.” Instead of using a single representation for the entire model, each model output (logit) is represented separately. The present method for extracting logit descriptors first presents each model with a set of n ordered, fixed input samples (probes). Intuitively, these are a set of standardized questions that may be presented as model inputs. In practice, the list of probes may be composed by randomly sampling images (without replacement) from an image dataset, e.g., from the COCO dataset (https://cocodataset.org/#home), which is highly diverse but also out-of-distribution for the tested models herein. Each probe xⱼ is input into the model ƒ, obtaining the output ƒ(xⱼ)[i] for the model's i^{th} logit. The present probing descriptor for logit i of model ƒ may be defined as the responses of all probes at this logit:

$$ϕ ( f , i ) = [ f ( {x}_{1} ) [ i ] , f ( {x}_{2} ) [ i ] , … , f ( {x}_{n} ) [ i ] ] \qquad ( 2 C )$$

To validate that logit responses to probes provide an effective description of the semantic function, the inventors conducted an experiment. The test comprised taking 10 different ViT foundation models, each trained via a different procedure, and fine-tune them on the CIFAR10 classification task (classifying small images into one of 10 object categories). The inventors randomly sampled 1,000 ImageNet images as probes, and ran them through each model, computing present probing description of each logit in each model (100 in total). Then, the correlation between all pairs of logits was computed. It may be observed that logit responses to probes are mostly correlated to those of logits with a matching semantic concept, rather than to logits from the same model.

For downstream tasks such as model retrieval, it is necessary to compute the discrepancy between pairs of logit-level probing descriptors. However, naive metrics such as Euclidean or correlation yield subpar results. Therefore, it may be hypothesized that models are only reliable for probes they are confident about, while their responses exhibit high variance for the others. To mitigate this phenomenon, the present technique focuses only on probes for which the query logit has high confidence about. Thus, the present technique introduces an asymmetric discrepancy measure, specifically designed for logit-level comparisons. Given a query logit descriptor, ϕ, its values (probe responses) are sorted from highest to lowest. Let a=[a₁, a₂, . . . , aₙ] be the indices of the sorted entries in descending order. Then, all gallery descriptors are reordered using the same index sequence a. Lastly, the discrepancy between the query and each of the gallery descriptors is computed by measuring the difference (in L₂) only over the top k probe entries of the sorted descriptors:

$$d ( ϕ , {ϕ}^{′} ) = \sqrt{{\sum }_{i = 1}^{k} {( {ϕ}_{{a}_{i}} - {ϕ}_{{a}_{i}}^{′} )}^{2}} \qquad ( 3 C )$$

where d(ϕ,ϕ′) is the discrepancy between the query descriptor ϕ and a gallery descriptor ϕ′.

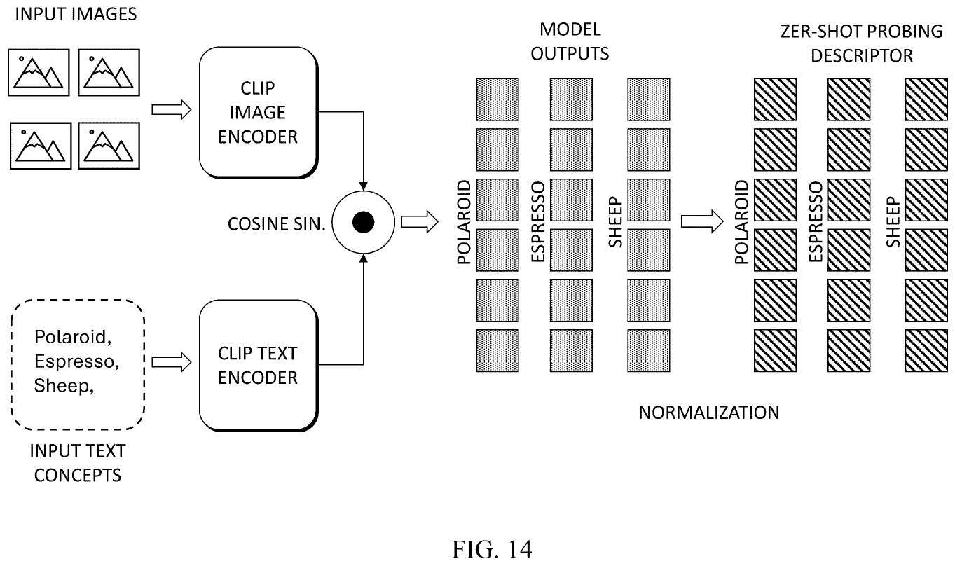

FIG. 14 schematically depicts text-aligned probing descriptors, according to the present technique. This technique creates probing representations for text prompts. In this case, each to the ordered probes is encoded using the CLIP image encoder. At inference time, the target text prompt is embedded, and its similarity with respect to the stored probe representations is computed. Using normalizing this zero-shot descriptor, it is possible to effectively search descriptors of real model logits, accurately retrieving similar concepts.

In some embodiments, the present technique provides for searching suitable models by logit, essentially finding similar logits to an existing one. in some embodiments, the present technique further provides for searching by text, thus allowing the user to search for concepts without already having a reference model trained to perform the same target task, making the search zero-shot. To do so, the present technique provides for generating probing descriptors from text alone, using a multimodal text alignment model (e.g., CLIP when the inputs are images). The multimodal model is used to extract embeddings from each probe αᵢ as well as from a user description αₜₑₓₜ of the target concept. The zero-shot probing descriptor of the target concept is defined as the vector of dot products between the embeddings of each probe and that of the target text:

$${ϕ}_{text} = [ {α}_{i} \cdot {α}_{text} , {α}_{2} \cdot {α}_{text} , … , {α}_{n} \cdot {α}_{text} ] \qquad ( 4 C )$$

Using the discrepancy measure described above between the logit and the zero-shot probing descriptors does not achieve good results, as their numerical values are in different scales. To reduce this domain gap, each descriptor is normalized by its mean and standard deviation. The normalized probing descriptor is:

$$ϕ ( f , i ) ← \frac{ϕ ( f , i ) - {μ}_{f , i}}{{σ}_{f , i}} \qquad ( 5 C )$$

where μ_{ƒ,i} and σ_{ƒ,i} indicate the mean and standard deviation of 0(ƒ, i) respectively.

In some embodiments, the present technique provides for collaborative probing, wherein the present technique creates probing descriptors for an entire model repository. Typically, this can be very costly, as it requires computing many forward passes for millions of models. Reducing this number of probes is critical for making the method practical. Therefore, in some embodiments, the present technique provides for collaborative probing. For each model in a repository, p % of the probes are randomly sampled, and probing descriptors are computed only for these probes, masking out the entries for all other probes. Therefore the probing descriptors for the logits of all models in the repository may be described as a sparse matrix X, with 1−p % of entries missing, where X_{i,j} is the response of logit i to probe j. The core idea is to use missing data imputation methods to complete this matrix, thus cheaply computing the full probing representations while actually probing each model with only a small fraction of the probes.

To complete the matrix X, the truncated SVD algorithm may be used. The idea is to decompose matrix X into low-rank matrices U, V such that:

$${U}^{*} , {V}^{*} = arg {min}_{U , V} {\vert ( {U}^{T} V - X ) ⊙ M \vert}^{2} \qquad ( 6 C )$$

where M is the mask matrix that has all ones expect for zeros for masked entries of X. This optimization problem may be solved using iterative optimization. This involves alternating between fixing U while optimizing V and vice versa until convergence. By the end of optimization, \tilde{X}=U^{T}V may be computed as the completed matrix. Computing the zero-shot probing embedding does not require any modification, as the probe embeddings can be cached. At inference time, the text embedding requires a single forward pass, and the zero-shot probing descriptor requires a single matrix vector multiplication. The retrieval then proceeds normally.

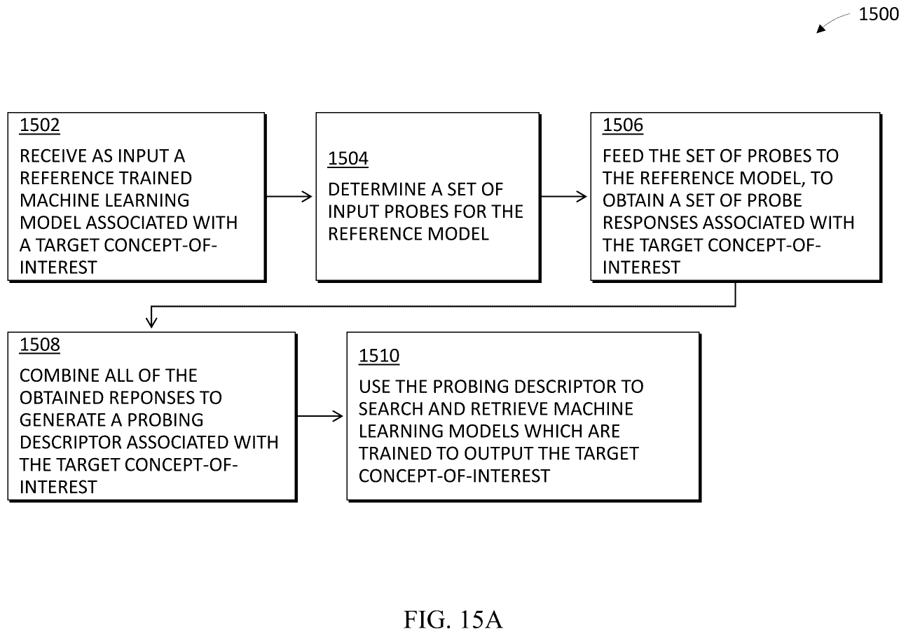

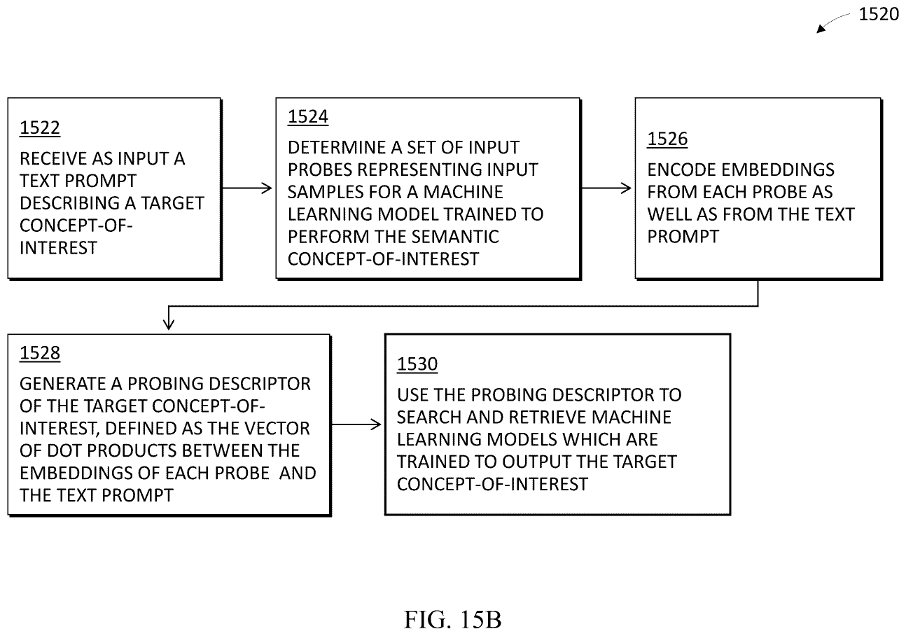

With reference back to FIG. 1, the instructions of machine learning model analyzer block 150 are now discussed with reference to the flowchart of FIG. 15A, which details the functional steps in a method 1500 which provides for generating a probing descriptor representing an output target concept-of-interest of a trained machine learning model. In some embodiments, method 1500 is configured for generating a probing descriptor for a target concept-of-interest (e.g., a semantic concept, such as a classification class) for which a machine learning model is trained. For example, where a machine learning model is trained to classify between two classes “dog” and “cat,” the present method provides for a probing descriptor which represents at least one of these classes (concepts). In some embodiments, the probing descriptor generated for a concept-of-interest can be used to search and retrieve machine learning models from a repository, which are trained to output the same concept.

Steps of method 1500 may either be performed in the order they are presented or in a different order (or even in parallel), as long as the order allows for a necessary input to a certain step to be obtained from an output of an earlier step. In addition, the steps of method 1500 are performed automatically (e.g., by computing system 100 of FIG. 1, or by any other applicable component of computing environment 100), unless specifically stated otherwise.

Method 1500 begins in step 1502, wherein machine learning model analyzer block 150 receives as input a reference trained machine learning model ƒ associated with a target concept-of-interest i (e.g., a classification output of interest).

In step 1504, machine learning model analyzer block 150 executes model analysis module 152 to determine a set of n ordered probes representing input samples for reference machine learning model ƒ. For example, in the case of a reference machine learning model ƒ configured for computer vision classification, the input probes may be images.

In some embodiments, the set of n probes may be randomly selected, e.g., comprising randomly sampled images from a dataset of images. For example, the target concept-of-interest may include an image classification of specific objects, while the set of probes may comprise images of scenes.

In some embodiments, the set of n probes may be selected from distributions that are semantically closer to the target concept-of-interest. For example, the target concept-of-interest may include an image classification output of “dog,” such that the set of probes may comprise images of dogs.

In step 1506, machine learning model analyzer block 150 executes model analysis module 152 to feed the set of n probes into reference machine learning model ƒ, to obtain a corresponding set of probe responses. Accordingly, machine learning model analyzer block 150 executes model analysis module 152 to input each probe xⱼ in the set of n probes into reference machine learning model ƒ, to obtain the output ƒ(xⱼ)[i] associated with the model's target concept-of-interest i^{th}.

In step 1508, machine learning model analyzer block 150 executes model analysis module 152 to combine all of the responses of all outputs of reference model ƒ probes associated with the model's i^{th} target concept-of-interest as ϕ(ƒ,i)=[ƒ(x₁)[i], ƒ(x₂)[i], . . . , ƒ(xₙ)[i]], to generate a probing descriptor associated with the semantic function of the target concept-of-interest i.

In some embodiments, machine learning model analyzer block 150 executes model analysis module 152 to further normalize the obtained responses.

In step 1510, the probing descriptor generated in step 1508 may be used to search and retrieve machine learning models that are trained to output the target concept-of-interest i, e.g., from a repository of machine learning models.

With reference back to FIG. 1, the instructions of machine learning model analyzer block 150 are now discussed with reference to the flowchart of FIG. 15B, which details the functional steps in a method 1520 which provides for generating a probing descriptor from a text prompt representing a semantic target concept-of-interest. In some embodiments, method 1520 is configured for generating a probing descriptor directly from a text prompt describing a semantic target concept-of-interest (e.g., a classification class) for which a machine learning model is trained. For example, where a machine learning model is trained to classify between two classes “dog” and “cat,” the present method provides for generating a probing descriptor from a text prompt describing the concept (e.g., “dog”). In some embodiments, the probing descriptor generated for a concept-of-interest can be used to search and retrieve machine learning models that are trained to output the same concept, e.g., from a repository of machine learning models.

Steps of method 1520 may either be performed in the order they are presented or in a different order (or even in parallel), as long as the order allows for a necessary input to a certain step to be obtained from an output of an earlier step. In addition, the steps of method 1520 are performed automatically (e.g., by computing system 100 of FIG. 1, or by any other applicable component of computing environment 100), unless specifically stated otherwise.

Method 1520 begins in step 1522, wherein machine learning model analyzer block 150 receives as input a text prompt αₜₑₓₜ describing a target concept-of-interest i (e.g., an image classification output of interest).

In step 1524, machine learning model analyzer block 150 executes model analysis module 152 to determine a set of probes representing input samples for a machine learning model trained to perform the semantic concept-of-interest. For example, in the case of machine learning model configured for computer vision classification, the input probes may be images.

In some embodiments, the set of probes may be randomly selected, e.g., comprising randomly sampled images from a dataset of images. For example, the target concept-of-interest may include an image classification of objects, while the set of probes may comprise images of scenes.

In some embodiments, the set of probes may be selected from distributions that are semantically closer to the target concept-of-interest. For example, the target concept-of-interest may include an image classification output of “dog,” such that the set of probes may comprise images of dogs.

In step 1526, machine learning model analyzer block 150 executes model analysis module 152 to encode embeddings from each probe αᵢ as well as from the text prompts αₜₑₓₜ. For example, machine learning model analyzer block 150 executes model analysis module 152 to use any suitable one or more encoders or a multimodal encoder (e.g., CLIP) to encode embeddings from each probe αᵢ as well as from the text prompt αₜₑₓₜ.

In step 1528, machine learning model analyzer block 150 executes model analysis module 152 to generate a probing descriptor of the target concept-of-interest, defined as the vector of dot products between the embeddings of each probe αᵢ and the text prompt αₜₑₓₜ, ϕₜₑₓₜ=[αᵢ·αₜₑₓₜ, α₂·αₜₑₓₜ, . . . , αₙ·αₜₑₓₜ]).

Optionally, machine learning model analyzer block 150 executes model analysis module 152 to normalize the generated probing descriptor by its mean and standard deviation, as

$$ϕ ( f , i ) ← \frac{ϕ ( f , i ) - {μ}_{f , i}}{{σ}_{f , i}} ,$$

where μ_{ƒ,i} and σ_{ƒ,i} indicate the mean and standard deviation of ϕ(ƒ, i) respectively.

In step 1530, the probing descriptor generated in step 1528 may be used to search and retrieve machine learning models that are trained to output the target concept-of-interest, e.g., from a repository of machine learning models.

### Experimental Results

The inventors created two experimental datasets termed INet-Hub and HF-Hub, to simulate a model hub with many classifiers.
Inet-Hub Dataset Details: Comprises 1,500 classifier models trained on different subsets of ImageNet classes. Each classifier is trained on a subset of between 15 and 200 classes, where the classes are selected at random separately for each model. 90% of the classifiers are initialized from a foundation model, and the rest 10% are trained from scratch. The pre-training weights are selected from a set of 49 different models spanning various architectures including ViTs, ResNets, RegNet-Ys, MLP Mixers, EfficientNets, ConvNexts and more. Each model is then trained for 2-5 epochs. This process results in a model hub with over 85,000 different logits for search, and 1,000 different fine-grained concepts.
HF-Hub Dataset Details: HF-Hub comprises 71 classifiers uploaded by users to hugging face. The classifiers were each trained on between 2 and 82 classes. Overall there are more than 400 possible logits in the dataset. The models are trained on a diverse set of models, and class names are given by free text. Hence, class names may not align perfectly, as each user spells concept a bit differently (e.g., “Apple” vs. “Apples”). Moreover, some classifiers have different levels of granularity, such as the concept “Car” vs. a specific car model “Toyota”. Therefore, the inventors created a label mapping where the classes to which each logit can be mapped were annotated. The mapping was configured such that: (i) different spellings map to each other, (ii) an object can be mapped to a specific type of it, e.g., “cat” mapped to “Siamese cat,” (iii) a specific type of object can be mapped to its super-class, e.g., “Siamese cat” mapped to “cat,” and (iv) object of the same level of granularity that share a super class cannot be mapped to each other. For example, a “Golden Retriever” is not a good match for a “Husky.” Additionally, an additional mapping was created which matches each class to its corresponding ImageNet concept when available.

The present probing descriptor was tested against two baselines: (i) model-level, and (ii) direct logit comparison. The model-level approach averages all probing descriptors of the model's logits, and searches for a similar logit descriptor to that model-level representation. The logit-level baseline does not use the discrepancy metric discussed above, but rather computes the Euclidean distance between a pair of logit representations.

The retrieval performance was evaluated using standard metrics: top-k accuracy and precision (with k∈[1,5]). Top-k accuracy measures the percentage of target logits that had a relevant result in any of their top-k retrieved logits. Top-k precision measures the percentage of all top-k retrievals across all target concepts that were relevant.

The Top-1 and Top-5 retrieval accuracies of the present method and the baselines were evaluated for search-by-logit and search-by-text. All methods use COCO images as probes. All experiments are performed with 4,000 probes.

Table 1B below reports retrieval results based on the Top-1 and Top-5 retrieval accuracies of the present method and the baselines for search-by-logit and search-by-text.

TABLE 1B

| Retrieval | Method | INet → INet | INet → HF | HF → INet |
|---|---|---|---|---|
| Top-1 | Full Query | 59.9% ± 0.2 | 14.8% ± 0.1 | 15.3% ± 0.8 |
| Accuracy | Model-Level | 0% ± 0. | 13.9% ± 1.0 | 21.0% ± 1.8 |
| | Present Probing | 72.8% ± 0.2 | 26.1% ± 0.8 | 40.6% ± 0.3 |
| | Descriptor | | | |
| Top-5 | Full Query | 82.8% ± 0.1 | 31.5% ± 0.1 | 19.7% ± 0.8 |
| Accuracy | Model-Level | 0% ± 0. | 34.6% ± 0.6 | 51.6% ± 2.0 |
| | Present Probing | 92.6% ± 0.1 | 43.6% ± 0.5 | 58.6% ± 0.9 |
| | Descriptor | | | |

| Retrieval | Method | text → HF | text → INet |
|---|---|---|---|
| Top-1 | Full Query | 22.6% ± 0.5 | 16.9% ± 0.2 |
| Accuracy | Model-Level | 17.8% ± 1.5 | 0% ± 0.0 |
| | Present Probing | 34.0% ± 1.5 | 43.8% ± 1.1 |
| | Descriptor | | |
| Top-5 | Full Query | 38.6% ± 1.1 | 22.8% ± 0.2 |
| Accuracy | Model-Level | 38.8% ± 1.8 | 0% ± 0.0 |
| | Present Probing | 53.7% ± 1.9 | 68.0% ± 0.6 |
| | Descriptor | | |

The present method was evaluated on 3 scenarios, with the results reported in Table 1B.

In the first scenario, performance was evaluated when target models come from the same distribution as the repository models. To test this, the INet-Hub dataset was split into 2 distinct subsets, and the retrieval performance was evaluated over the two splits. In this setting, the present probing descriptor achieves a top-1 accuracy of 70%, such that more than two thirds of target logits have the correct concept as their top retrieval result.

The second scenario comprises queries that are out-of-distribution to the repository. To test this, real model logits (HF-Hub dataset) were searched in the INet-Hub dataset and vice versa. This is especially difficult as the INet-Hub dataset contains logits corresponding to ImageNet classes that are quite fine-grained. Still, the present probing descriptor obtains top-1 retrieval accuracy of 40.6% in the HF→INet task, compared to both baselines which are at 21%.

In the search-by-text evaluation, the test searched for the closest retrievals to a zero-shot text descriptor in either the INet-Hub or the HF-Hub datasets. As can be seen in table 1B, in both cases, the present method accuracy greatly exceeds the baselines, reaching an impressive top-1 accuracy of 43.8% on the INet-Hub dataset. Moreover, when tested on the HF-Hub dataset, it can be seen that the present method generalizes to real-world models, as it finds suitable matches for more than a third of the queries in the first search result, and for more than half of the queries within the first 5 retrievals. This shows that while simple, the present approach can generalize to real-world scenarios where user models are searched for using just a simple text prompt.

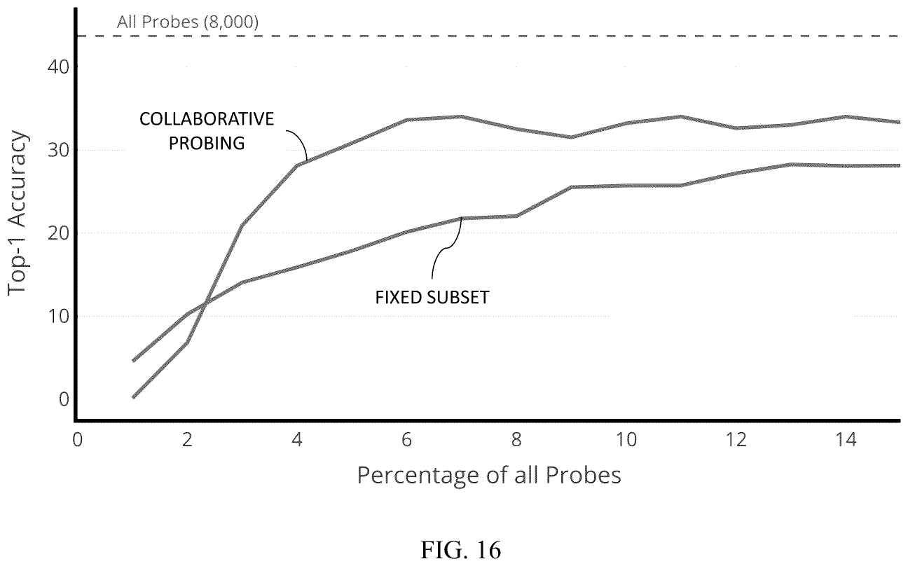

The inventors further tested collaborative probing, by sampling a number of randomly selected probes for each model against simply using the same probes for all models. FIG. 16 presents the results of the collaborative probing test. The present collaborative probing method was tested on a text→INet-Hub retrieval task. While the full size of the dataset is 8,000 COCO probes, the graph shows cases where each model is probed by less than 15% of these probes. As can be seen, collaborative probing can improve accuracy by as much as 2×. While the present collaborative probing technique requires around 400 probes per model to be effective, it can then substantially improve probing efficiency. Specifically, it reaches similar results as the standard approach with less than a third the number of probes. For example, having just 4% of all probes per model, is just as good as probing all models with 15% of all probes. This highlights the potential of the present collaborative probing technique to significantly improve the efficiency of the present search approach.

As discussed above, the present probing descriptor can generalize to real-world scenarios. the inventors thus conducted an ablation study, to test the effect of sampling probes from different distributions: (i) Dead-Leaves (Baradad Jurjo, M., et al. Learning to see by looking at noise. Advances in Neural Information Processing Systems, 34:2556-2569, 2021), a very coarse, hand-crafted generative model, (ii) ImageNet images, (iii) Stable Diffusion samples using prompts of ImageNet-21K objects, and (iv) COCO Images. The results are reported in Table 2B. as can be seen, there is a consistent pattern: probes sampled from distributions that are closer to the target concept obtain more accurate retrievals. However, even different probe distribution can yield high retrieval accuracies. For example, even though COCO images are typically of scenes rather than objects, they are effective probes, reaching a top-5 accuracy of more than 60% when searching the INet-Hub dataset by text. These results show that defining a general set of probes, which can retrieve a wide range of concepts is feasible. However, if a prior knowledge about the distribution of target concepts exists, then it is better to select in-distribution probes.

TABLE 2B
The inventors further compared both real and synthetic probe distributions. While distributions
closer to the model's training data lead to better results, even out-of-distribution
probes sampled from the COCO dataset retrieve relevant logits with high accuracy.

| | Top-1 Accuracy | | | Top-5 Accuracy | | |
|---|---|---|---|---|---|---|
| Method | HF → INet | text → HF | text → INet | HF → INet | text → HF | text → INet |
| Dead-Leaves | 1.3% ± 0.7 | 1.6% ± 1.4 | 1.0% ± 0.2 | 5.9% ± 1.6 | 6.8% ± 1.3 | 3.8% ± 0.2 |
| Stable- | 51.4% ± 1.0 | 36.9% ± 0.9 | 47.0% ± 0.6 | 69.8% ± 0.9 | 56.2% ± 0.9 | 73.3% ± 0.9 |
| Diffusion | | | | | | |
| ImageNet | 57.8% ± 1.3 | 33.1% ± 1.2 | 55.4% ± 1.1 | 71.4% ± 1.3 | 55.1% ± 0.9 | 80.4% ± 0.9 |
| COCO | 40.6% ± 0.3 | 34.0% ± 1.5 | 43.8% ± 1.1 | 58.6% ± 0.9 | 53.7% ± 1.9 | 68.0% ± 0.6 |

As discussed above, the inventors proposed a discrepancy metric that compares the query and retrieved logits only on the probes that the query logit obtained large values on. The inventors further ablated this choice of metric, comparing to several other probe selection criteria: lowest value probes, random sampling, uniform quantile sampling, highest value probes without normalization, and using all probes. The results, presented in Table 3B below, show that selecting the highest valued probes of the query logit is crucial for successful retrieval. This may be because logit values tend to be noisy, and highly confident values should be more consistent across logits of the same concept.

TABLE 3B
Logit Discrepancy Ablations. The present evaluation reveals: i) normalizing logit descriptors
is necessary for accurate retrieval, especially for search-by-text. ii) choosing the most confident
probes of the query logit is crucial, no other approach achieved comparable accuracy.

| Selected | Top-1 Accuracy | | | Top-5 Accuracy | | |
|---|---|---|---|---|---|---|
| Probes | HF→INet | text→HF | text→INet | HF→INet | text→HF | text→INet |
| Top-k + | 1.9% ± 0.4 | 0.1% ± 0.1 | 0% ± 0.0 | 5.0% ± 0.9 | 0.5% ± 0.2 | 0.6% ± 0.1 |
| No Norm. | | | | | | |
| Bottom-k | 0.8% ± 0.3 | 1.3% ± 0.9 | 2.3% ± 0.5 | 1.2% ± 0.3 | 6.8% ± 0.5 | 7.9% ± 0.9 |
| Random | 8.6% ± 1.2 | 2.5% ± 1.4 | 6.3% ± 0.5 | 16.2% ± 1.5 | 8.6% ± 1.2 | 16.7% ± 0.7 |
| Quantiles | 7.7% ± 2.0 | 5.9% ± 1.0 | 5.8% ± 0.5 | 17.9% ± 3.8 | 15.3% ± 1.8 | 16.4% ± 1.7 |
| All | 15.3% ± 0.8 | 22.6% ± 0.5 | 16.9% ± 0.2 | 19.7% ± 0.8 | 38.6% ± 1.1 | 22.8% ± 0.2 |
| Top-k | 40.6% ± 0.3 | 34.0% ± 1.5 | 43.8% ± 1.1 | 58.6% ± 0.9 | 53.7% ± 1.9 | 68.0% ± 0.6 |

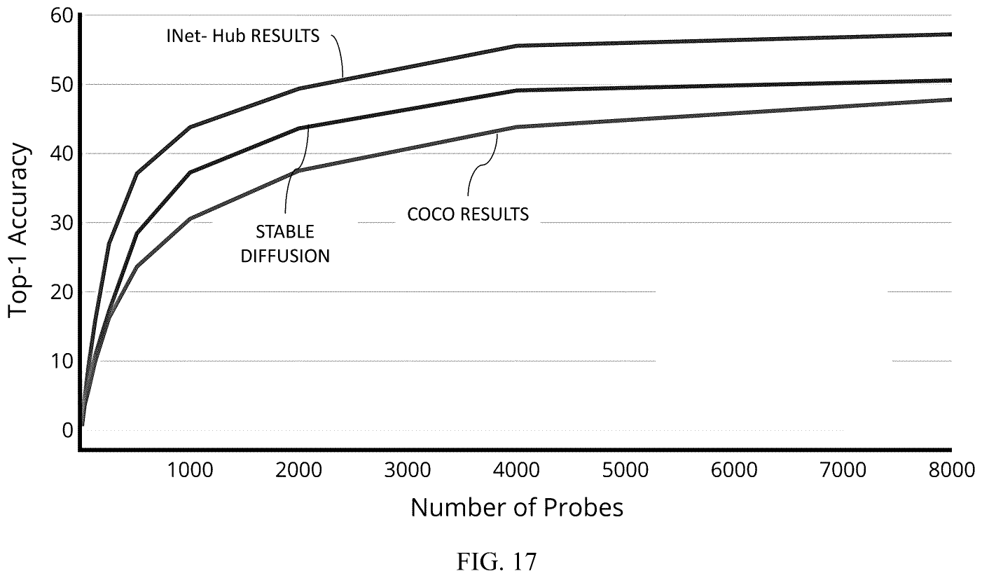

FIG. 17 presents results of text retrieval on the INet-Hub dataset using increasing numbers of probes. More probes lead to better results but with diminishing gains. For example, 4,000 COCO probes are enough for good performance of 43.8% top-1 accuracy, though it is possible to achieve a 47.8% using 8,000 probes.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range −10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A computer-implemented method comprising:
receiving, as input, a set of machine learning models associated with a repository of models, wherein a creation time for each of said models in said set with respect to said repository is known;
determining a distance measure with respect to each pair of models in said set, based, at least in part, on a set of internal learned representations which determine how each of said models processes and encodes input data; and
predicting, for each model m in said set, a parent model p from which said model m was generated via additional training, based, at least in part, on (x) said distance measure, and (y) temporal order and distance determined based on said creation time, between said model m and said parent model p.

2. The computer-implemented method of claim 1, further comprising constructing a visualized graph representation of said set of machine learning models, wherein each of said models m in said set is a node in said graph, and wherein each of said nodes is connected with a directed edge to a respective said parent model p thereof.

3. The computer-implemented method of claim 1, wherein said predicting is performed iteratively for each of said models m in said set, in a temporal order based on said creation time, by:
(i) determining a subset K of nearest neighbors of said model m, based on said distance measure,
(ii) calculating a correlation between (a) said distance measures and (b) temporal distances determined based on said creation time, between said model m and each of said models in said subset K,
(iii) when said correlation exceeds a predetermined threshold, designating as said parent model p the nearest one of said models in said subset K having a said creation date which precedes said creation date of said model m, and
(iv) when said correlation is below said predetermined threshold, designating as said parent model p said model in said subset K having the earliest said creation time.

4. The computer-implemented method of claim 1, wherein said internal set of learned representations are learned weight representations, and wherein said distance measure is based on measuring a Euclidean distance between each pair of said models in said set based on their respective said learned weight representations.

5. The computer-implemented method of claim 4, wherein said predicting is further based, at least in part, on a difference in a number of outlier values in said learned weight representations of model m and parent model p, wherein a lower said number of outlier values indicates a model which has undergone additional training.

6. The computer-implemented method of claim 1, further comprising (i) identifying duplicate pairs of said models in said set when said distance measure between a pair of said models is below a distance threshold, and (ii) removing from said set one of said models in each of said identified duplicate pairs.

7. The computer-implemented method of claim 1, wherein an indication of a quantization process is known for each of said models in said set, and wherein said method further comprises designating each of said models having said indication of a quantization process as a leaf node in said visualized graph representation.

8. The computer-implemented method of claim 1, wherein said creation time indicates a time of creation or an uploading time for each of said models in said set with respect to said repository.

9. A system comprising:
at least one processor; and
a non-transitory computer-readable storage medium having stored thereon program instructions, the program instructions executable by the at least one processor to:
receive, as input, a set of machine learning models associated with a repository of models, wherein a creation time for each of said models in said set with respect to said repository is known,
determine a distance measure with respect to each pair of models in said set, based, at least in part, on a set of internal learned representations which determine how each of said models processes and encodes input data, and
predict, for each model m in said set, a parent model p from which said model m was generated via additional training, based, at least in part, on (x) said distance measure, and (y) temporal order and distance determined based on said creation time, between said model m and said parent model p.

10. The system of claim 9, wherein said program instructions are further executable to construct a visualized graph representation of said set of machine learning models, wherein each of said models m in said set is a node in said graph, and wherein each of said nodes is connected with a directed edge to a respective said parent model p thereof.

11. The system of claim 9, wherein said predicting is performed iteratively for each of said models m in said set, in a temporal order based on said creation time, by:
(i) determining a subset K of nearest neighbors of said model m, based on said distance measure,
(ii) calculating a correlation between (a) said distance measures and (b) temporal distances determined based on said creation time, between said model m and each of said models in said subset K,
(iii) when said correlation exceeds a predetermined threshold, designating as said parent model p the nearest one of said models in said subset K having a said creation date which precedes said creation date of said model m, and
(iv) when said correlation is below said predetermined threshold, designating as said parent model p said model in said subset K having the earliest said creation time.

12. The system of claim 9, wherein said internal set of learned representations are learned weight representations, and wherein said distance measure is based on measuring a Euclidean distance between each pair of said models in said set based on their respective said learned weight representations.

13. The system of claim 12, wherein said predicting is further based, at least in part, on a difference in a number of outlier values in said learned weight representations of model m and parent model p, wherein a lower said number of outlier values indicates a model which has undergone additional training.

14. The system of claim 9, wherein said program instructions are further executable to (i) identify duplicate pairs of said models in said set when said distance measure between a pair of said models is below a distance threshold, and (ii) remove from said set one of said models in each of said identified duplicate pairs.

15. The system of claim 9, wherein an indication of a quantization process is known for each of said models in said set, and wherein the program instructions are further executable to designate each of said models having said indication of a quantization process as a leaf node in said visualized graph representation.

16. The system of claim 9, wherein said creation time indicates a time of creation or an uploading time for each of said models in said set with respect to said repository.

17. A computer program product comprising a non-transitory computer-readable storage medium having program instructions embodied therewith, the program instructions executable by a computer system to:
receive, as input, a set of machine learning models associated with a repository of models, wherein a creation time for each of said models in said set with respect to said repository is known;
determine a distance measure with respect to each pair of models in said set, based, at least in part, on a set of internal learned representations which determine how each of said models processes and encodes input data; and
predict, for each model m in said set, a parent model p from which said model m was generated via additional training, based, at least in part, on (x) said distance measure, and (y) temporal order and distance determined based on said creation time, between said model m and said parent model p.

18. The computer program product of claim 17, wherein said program instructions are further executable to construct a visualized graph representation of said set of machine learning models, wherein each of said models m in said set is a node in said graph, and wherein each of said nodes is connected with a directed edge to a respective said parent model p thereof.

19. The computer program product of claim 17, wherein said predicting is performed iteratively for each of said models m in said set, in a temporal order based on said creation time, by:
(i) determining a subset K of nearest neighbors of said model m, based on said distance measure,
(ii) calculating a correlation between (a) said distance measures and (b) temporal distances determined based on said creation time, between said model m and each of said models in said subset K,
(iii) when said correlation exceeds a predetermined threshold, designating as said parent model p the nearest one of said models in said subset K having a said creation date which precedes said creation date of said model m, and
(iv) when said correlation is below said predetermined threshold, designating as said parent model p said model in said subset K having the earliest said creation time.

20. The system of claim 9, wherein said internal set of learned representations are learned weight representations, and wherein said distance measure is based on measuring a Euclidean distance between each pair of said models in said set based on their respective said learned weight representations.
